(19) United States
(12) Patent Application Publication
(10) Pub. No.: US 2026/0279137 A1
(43) Pub. Date: Sep. 17, 2026

(54) SYSTEMS AND METHODS OF MIXED REALITY PHYSICAL GAMING ARENAS

(71) Applicant: AWAGER LTD, Tel Aviv (IL)

(72) Inventor: Roy GREENBAUM, Haifa (IL)

(21) Appl. No.: 19/561,378

(22) Filed: Mar. 9, 2026

Related U.S. Application Data
(60) Provisional application No. 63/772,078, filed on Mar. 14, 2025.

(51) Int. Cl. G07F 17/32

(52) U.S. Cl. CPC G07F 17/3211; G07F 17/3239

(57) ABSTRACT

Systems and methods are disclosed facilitating live Mixed Reality exploration of physical gaming arena including a plurality of electronic gaming machines (EGMs). Plurality of imagers are distributed in the arena to facilitate multiscopic capture of imagery/view aspects thereof the gaming arena. Mapping data indicative of the positions of the imagers in the gaming arena and the imagery captured thereby is used to render a visual view of the physical gaming arena as viewed from a virtual user’s position within the arena and thereby provide the remote user with real time live multimedia content presenting the arena from the position. The virtual user’s position can be moved in the arena allowing the user to explore the arena and gaming machines therein in live, as well as in some cases to interact and operate the gaming machines in the arena in real time.

### CROSS REFERENCE TO RELATED APPLICATIONS

This application claims benefit under 35 U.S.C. §119(e) of Provisional U.S. Patent Application No. 63/772,078, filed Mar 14, 2025, the contents of which is incorporated herein by reference in its entirety.

### TECHNOLOGICAL FIELD

The present disclosure is in the field of mixed reality and particularly relates to mixed reality streaming of gaming arenas.

### BACKGROUND

Websites and applications of gaming are widely used for playing games, some of which may include gambling on-line. In some cases, most games provided on-line by such sites and/or applications resemble conventional games, including casino games/gaming machines. For example, typical on-line gaming sites may include virtual video slot machines, virtual video poker machines, and even virtual mechanical slot machines.

However, actual/physical electronic machines used for gaming (e.g., also known as electronic gaming machines (“EGMs”)), such as those placed in casinos, are typically strictly regulated to ensure their reliability and to provide users with legitimate winning chances. For example, an EGM may include regulated/supervised computer chip(s) on which the game’s computer software is stored and implemented, whereby the regulated/supervised chip(s) are associated with various mechanisms to prevent their forgery and/or unauthorized replacement.

There exist some conventional techniques aimed at improving the versatility of gaming machines, but further improvements related to the versatility and productivity of EGMs, particularly by facilitating their use from remote locations, are needed.

### GENERAL DESCRIPTION

The present disclosure is directed to facilitating real time remote on-line interaction of a remote user(s) with a physical arena including electronic machines (“EMs”). Further disclosure is also provided associated with facilitating live three-dimensional mixed reality experience/interaction of remote on-line users with physical arenas, and in particular in arenas including various EMs, to facilitate approach to, and in some cases remote control of, the physical machines in the arena via mixed reality equipment (i.e., without a need to be physically within the arena in order to activate the machines).

In the following, the term arena is used to designate a physical/tangible location/region, such as a stadium hall and/or other designated physical area/location in which certain events may take place. A particular interest of the disclosure is in the field of gaming and relates to gaming arenas, such as casinos or other gaming rooms with a plurality of Electronic Gaming Machines (EGMs) therein, such as arcade games, slot machines, video poker machine or other EGM types, as well as Electronic Table Games (“ETGs”), such as roulette, craps, blackjack, and various amusement games.

Indeed, many existing on-line gaming sites and/or gaming applications are aimed at providing users with an experience like that of a real-life casino. Typically, such sites/applications offer games similar to those existing in actual casino gaming machines and might also provide users with gambling options similar to those available at conventional gaming arenas/casinos.

However, a major difference between actual/physical casino games/gaming machines and their virtual implementations provided by such on line sites, stems from that actual casino gaming machines typically provide predetermined and in many cases a-priori known/published gambling odds (e.g., gambling return rates and/or winning chances), which are, as noted above, are under strict regulations in at least some jurisdictions. Conversely, in some virtual on-line gaming sites/applications (e.g., offering virtual casino experiences), the virtual games/gaming machines are not under strict regulations and are not supervised, and/or their users cannot determine reliability of the virtual gaming machine and/or its actual gambling odds. Also, in jurisdictions, which do impose some regulation on such on-line gaming sites/applications, the on-line/virtual machines are typically more loosely regulated than actual casino gaming machines.

To this end, even if such on-line games/sites are provided from/by strictly regulated systems, they are often viewed by the remote users as un-reliable, since they appear like the other on-line games which may be not regulated, as compared to land-based/actual gaming arenas with are known to go through strict regulatory processes. Accordingly, the user's experience when playing actual gaming machines/arena is often better than that obtained when the user engages with the counterpart virtual machines/arenas.

The present disclosure may be used to improve a user's access to remote physical arenas, such as gaming arenas, via mixed reality technologies, and is inter-alia aimed at improving the remote user experience when exploring such arenas and/or electronic machines therein, from remote and providing the remote user with an immersive live real time experience of the remote physical arena. Aspects of the present disclosure are also directed to facilitate the remote user with the ability to interact with and/or operate the physical electric gamine machines in the arena, as if he is attending the arena, by utilizing virtual reality gear to do so from afar. In line with that, the technique of the disclosure may be used to provide/stream to the user a real live experience (e.g., in 3D) of the real live events occurring in the physical arena. For instance, some implementations of the disclosure in the field of gaming allow the remote user to explore the gaming arena in live, experience real live actions of actual people and/or events performed in the arena as well as optionally playing the actual/physical electronic gaming machines there and/or gambling on the results of such games.

To this end, broad aspects of the disclosure provide systems and methods to facilitate live Mixed Reality exploration of physical gaming arena including a plurality of EGMs, ETGs, or other EMs (collectively referred to as EGMs herein). A plurality of imagers are distributed in the arena to facilitate multiscopic capture of imagery/view aspects of the gaming arena, and mapping data indicative of the positions of the imagers in the gaming arena and the imagery captured thereby is used to render a visual view of the physical gaming arena as viewed from a virtual user’s position within the arena and thereby provide the remote user with real time live multimedia content presenting the arena from the virtual user’s position. The virtual user’s position can be moved in the arena allowing the user to explore the arena and gaming machines therein in live. In some embodiments the remote user can interact and operate the gaming machines in the arena in real time.

Additionally, some aspects of the disclosure provide systems and methods to facilitate effective utilization of an arena with electronic gaming machines therein. The gaming arena may include a plurality of EGMs with one or more of the EGMs being arranged such that they are inaccessible to local visitors of the gaming arena (e.g. arranged on a wall of the arena at heights not suited for their operation by the local visitors physically attending the arena). The gaming arena includes a remote machine operation system facilitating remote operation of one or more of the EGMs by remote users located afar from the arena, in real time. This makes it possible to accommodate more machines in the arena while reducing the ground/floor space in the arena that is needed to accommodate these machines, while facilitating operation of the inaccessible machines in the arena by the remote users.

Further features and embodiments of the disclosure are described in the detailed description and examples sections below, in more detail.

In this regard it should be noted that the term imagery is used herein to designate video, images, or sequences of images/image-frames, captured by the imagers and from which a novel views of the arena can be produced to provide the remote user with live footage (e.g., video and/or sequence of frames) presenting the physical arena in substantially real time from a desired vantage point – e.g., being the user’s virtual position in the arena. The terms mapping and 3D-mapping and 3D-map or map, are used herein interchangeable to designate a mapping of positions (e.g., encompassing both locations and orientations) to physical locations (e.g., physical “voxels”) in the arena.

The term “mixed reality” (“MR”) is used herein to designate a technology, systems and/or methods, that facilitate capturing live-action multimedia content from a real physical place or arena and streaming such content for display to a user via “virtual reality” (“VR”) equipment (also known as XR equipment), often in 3D, to a user. Particularly it refers to such MR technology where the live-action multimedia content is captured using sensors, typically including imagers and potentially other sensors, that are suited for sensing real live action in the physical place or arena. This real-time content allows users to virtually navigate within the physical arena and may also enable them to operate certain facilities or machines within the real physical environment of the arena. Optionally, MR also provides for integrating real-world and virtual content, such as an avatar of the user. The term “VR equipment” is used herein to refer to any suitable virtual/augmented/mixed reality equipment (e.g., VR gear/setup) used by a user or player. VR equipment may for instance include a VR headset (i.e., a device worn on the head that provides the visual and auditory experience of virtual reality); VR controllers (e.g., handheld devices that allow the user to interact with the virtual/mixed reality environment); VR sensors (e.g. devices that track the movement and position of the user within the virtual space); and /or other VR hardware. Non-VR (multimedia) equipment is used herein to refer to devices and tools that a user can utilize to experience multimedia content without relying on virtual reality technology. Instead of VR gear, users can employ such equipment to engage with audio, video, images, and animations in a more traditional manner. For example, utilizing display monitors or projectors to display visual content; speakers or headphones for audio playback as well as cameras/microphones and/or other controllers or sensors such as Joystick/keyboard/Kinect-sensor or the like for input of control commands or other visual/auditory or movement data. In some embodiments of the disclosure users with non-VR equipment may be allowed to access the system of the disclosure allows users to enjoy rich multimedia experiences of the physical arena without the need for VR gear.

The term “rendering” is used herein to designate a process of synthesizing visual and possibly auditory data from multiple sources, to create multimedia content that presents this data from a specific vantage point or perspective. The multimedia content may consist of raw visuals and/or auditory elements, or it might be presented by vectorized representations that may require further additional processing for their display by the multimedia equipment, such as VR or non-VR equipment, of the end user who is to experience the multimedia data. In this regard, it should be noted that the terms multi-scopic or multiscopic and stereoscopic, are used herein in relation to imagery to refer the multiple images captured from different viewpoints, perspectives or angles, which allow 3D reconstruction of visual data of a scene/arena from a certain vantage points (whereby stereoscopic it typically used to the use of two images, and multiscopic to two or more, by which it may be possible to extract more accurate depth information and improve the overall quality of the reconstruction). In like manner terms related to spatial audio processing/production are used herein to refer to one or more techniques which might be employed to processes audio from multiple sources/audio pickups to produce audio representation from a particular vantage point within an arena. This may include proper mixing of the audio sources using techniques such as binaural audio, ambisonics, or surround sound levels, to simulate the spatial distribution of sounds as would be hearable from the desired vantage point within the arena, to create an immersive audio experience.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic illustration of a gaming arena 1000 including a plurality of electronic gaming machines 120 and a mixed reality system 100 according to an embodiment of the present disclosure;

FIG. 2 is a flow diagram exemplifying a method 200 according to an embodiment of the present disclosure, to provide immersive mixed reality content of an arena 1000, which includes a plurality of electronic machines, to a remote user 1 (shown in FIG. 3);

FIG. 3 is a block diagram of exemplifying a configuration of the mixed reality system 100 according to a non-limiting embodiment of the present disclosure;

FIG. 4 is a flow diagram exemplifying a method 260 according to an embodiment of the present disclosure, to facilitate interaction of remote user with the electronic machines 120 in the arena based on provided to him via method 200;

FIG. 5 is a flow diagram of a method 500 to facilitate effective utilization of a physical arena having electronic machines therein; and

FIG. 6. is a schematic illustration of an arena 2000 with a remote machine operation system 400 according to an embodiment of the disclosure, and plurality of electronic machines 120 some of which are accessible for exclusive operation via said remote machine operation system 400.

### DETAILED DESCRIPTION OF EMBODIMENTS

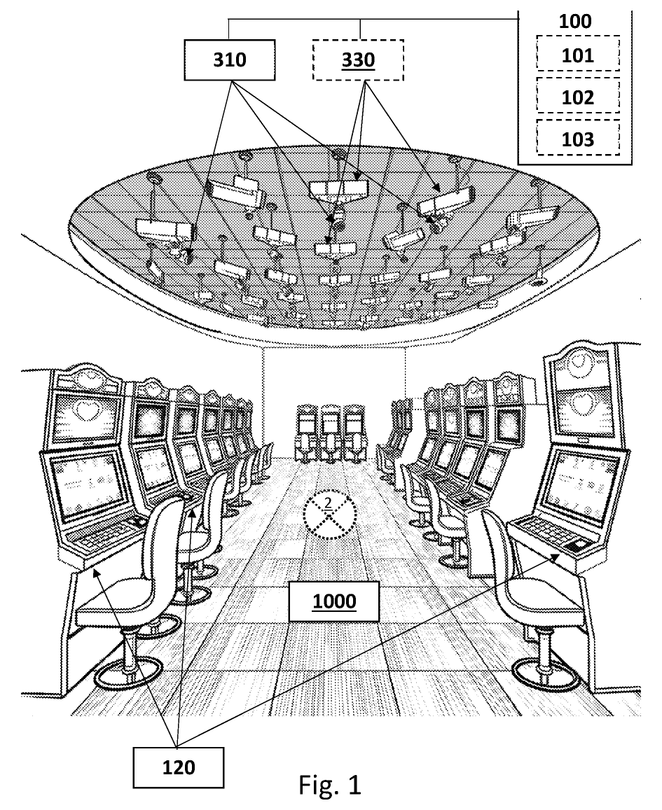

Reference is now made to FIG. 1 schematically illustrating a gaming arena 1000 including a plurality of EGMs 120. The arena 1000 is equipped with a mixed reality system 100 according to an embodiment of the present disclosure, which is capable of providing remote users with an immersive mixed reality content of the arena 1000 and in some implementations enable the remote users to interact and operate the electronic machines 120 from afar. The system 100 integrates live, real-world events of the arena optionally with digital enhancements and transmits the augmented experience to remote users in VR mode or optionally in non-VR mode. The system 100 utilizes various sensors, such as image-grabbers 310 (e.g., imagers such as video cameras), and optionally audio pickup devices 330 to capture multimedia information of the arena 1000 including live imagery and typically also audio. The image-grabbers 310 may in some cases also include machines’ display adapters capable of capturing display/video outputs of one or more of the machines 120 (e.g., directly or via a centralized machine’s server connected to the machines 120). In like manner the audio pickup devices 330 may include microphones or other sound sensors used to capture audio signals from the arena’s environment, as well as optionally audio adapters capable of capturing audio outputs of one or more of the machines 120 (e.g., directly or via centralized machine’s server connected to the machines 120).

The collected multimedia information of the arena 1000 is then processed to form immersive multimedia content of the arena 1000 as would be viewed/captured from the vantage point of the virtual position of the remote user within the arena, allowing the remote user to experience events in the arena as if they were physically present. Optionally in some embodiments the multimedia content of the arena 1000 is further enhanced by combining the multimedia content of the arena 1000 with digital visual elements, such as overlay animations and/or interactive elements, which may represent the remote user himself (or parts thereof) and/or entertainment/amusement visual elements such as gifts/bonuses, which may be produced by the system and incorporated in the immersive multimedia content of the arena 1000 provided to the remote user. The remote users can navigate within the arena 1000 (i.e., change its virtual position within the arena), and optionally interact with the electronic machines 120 therewithin, as well as optionally with some of interactive digital visual elements overlayed in the multimedia content provided to him, to enjoy a rich blended reality that merges the physical view of the arena with virtual user experience in the arena 1000. In this connection it should be noted that the terms position and positioning is used herein to designate both a 3D location and orientation within a volumetric space.

To this end, as illustrated in FIG. 1, the mixed reality system 100 is associated with a plurality of imagers 310 arranged at various locations in the arena 1000 to capture imagery (e.g., video footage) thereof from a plurality of vantage points, and optionally also directly or indirectly from display outputs of the electronic machines thereat. Optionally, in some embodiments the system is also associated with a plurality of audio pickup devices 330 capable of capturing audio from the arena 1000 and optionally also directly or indirectly from audio outputs of the electronic machines 120 thereat.

The system 100 is adapted to communicate with multimedia equipment of each remote user connected thereto, associate the remote user with a virtual user’s position 2 within the physical arena 1000, and provide the remote user (i.e., via communication with its multimedia equipment), with real time media content presentative of the physical arena 1000 as would be captured from the vantage point of the virtual user’s position 2. The provided media content 132 may include imagery (e.g., video) presenting the physical arena 1000 as viewed from the vantage point of the virtual user’s position, and optionally also audio content of the arena 1000. The system 100 is also adapted to communicate with multimedia equipment of the remote user to obtain navigation instructions and accordingly update/move the virtual user’s position 2 within the arena.

The system 100 is adapted to operate in real time to process the multimedia content captured from the physical arena 1000 (imagery and optionally audio) to synthesize real time live views of the arena 1000 from the perspective/vantage-point of the current virtual user’s position 2 and communicate the same, in live, to the multimedia equipment of the remote user. The may achieved for example utilizing view synthesis techniques for “stitching” together, or otherwise combining, the imagery captured by the imagers 310 from different perspectives, to create a seamless novel view of the arena from the desired vantage point 2. Alternatively, or additionally, this may be achieved by implementing novel-view generation techniques as exemplified below in order to create the seamless novel view of the arena from the desired vantage point 2, efficiently and in real time.

It should be noted that in some implementations, the systems/methods of the disclosure are adapted to obtain or produce 3D mapping data MD indicative of the positions (e.g., 3D coordinates and angles/orientations) of the imagers 310 and the machines 120 in the arena 1000 and optionally also of the fields of view of the imagers (“FOVs”; e.g., their numerical apertures) relative to the arena 1000 in three dimensions. In some implementations the mapping data MD also includes data indicative of the volumes (e.g., physical voxels) within the arena which are occupied by the machines 120, and/or by different controls or other elements thereof (such as their displays and/or cabinets). This may facilitate enhancing the visual appearances of such elements of the machines, like their cabinets, in the mixed reality view, with overlay graphics, for instance in order to improve their aesthetic appeal. Production of the mapping data MD may be performed during a calibration/setup stage of the system, at which it is adapted to the specific arena with the specific distribution/arrangement of imagers and machines therein. In that stage, the mapping, i.e., 3D mapping, may be for instance be obtained as input from an operator of the system, and/or inferred from imagery collected by the imagers (e.g., by utilizing suitable image processing/recognition techniques and/or artificial intelligence network adapted for this purpose. Such a 3D map may then enable view synthesis of the arena from new perspectives and angles, resulting in an immersive visualization of the arena and ensures that even unseen viewpoints can be rendered accurately, to present dynamic representation of the 3D space of the arena with the machines therein based real time imagery collected from the imagers.

In some embodiments advance novel view generation techniques are used for the view synthesis, to achieve high quality live view synthesis in real time. In this regard, the term Novel View generation is used herein to refer to the process of utilizing a plurality of imagers strategically placed around an arena to capture comprehensive visual data from multiple angles. This visual data is then processed and synthesized by advanced algorithms to produce a seamless images or video from a desired vantage point (e.g., the virtual user’s position 2), providing an immersive and flexible visual representation of the arena 1000 in real time, as if viewed from the desired vantage point. In some implementations a Novel View of the arena 1000 from a desired vantage point 2, may be generated by utilizing one or a combination of various rendering technologies, such as Neural Radiance Fields, real-time scene tracking algorithms, 3D-aware image generation using 2D-Diffusion, generative neural networks, such as generative adversarial networks, as well as other technologies. In some embodiments of the present disclosure, in order to facilitate an efficient real time generation of a live view of the scene (arena) from the desired vantage point, the systems and method of the present disclosure leverages pre-trained novel view generation technologies, as some implementations of Neural Radiance Fields, 3D-Aware Diffusion, and Generative Adversarial Networks (“GANs”), to handle production of the static parts of the scene, and utilizes Real-time tracking algorithms to process the live imagery obtained from the imagers to identify dynamic changes/elements, such as moving objects/people in the scene, so that only those changes need to be rendered in real time. For instance, in some implementations Real-time tracking algorithms continuously process the imagery to monitor moving objects/people in the scene, allowing the system to dynamically update the novel view thereof to properly incorporate novel views of the dynamic/moving objects therein in real time. Additionally, or alternatively, in some embodiments autoregressive view generation techniques are implemented to generate consistent sequences of novel views by considering both previous frames and real-time inputs. In some implementations, additionally, fixedly located dynamic parts of the arena 1000, such as the contents of display screens of the electronic machines 120 therein, are acquired in real-time directly from display adapters associated-with/connected-to, the machines 120, and embedded into the novel view with proper pan and tilt adjustments. This ensures efficient real-time rendering of display outputs. This hybrid approach ensures that both static and dynamic aspects of the environment are accurately represented, producing a seamless and immersive live novel view of the arena 1000 from the vantage point of the virtual user’s position 2 in real time.

In this regard, it should be noted that in some implementations the imagers 310 which are arranged in the arena 1000 and connectable to the system 100 may include visual cameras (e.g., video), and optionally also depth sensors or LiDARs capable of capturing depth information by which efficient identification of moving objects in the scene and/or efficient novel view generation/rendering may be assisted. Optionally, in some cases, display outputs of certain machines or devices in the arena are captured and embedded in the novel view with proper pan and tilt adjustments to ensure a cohesive and accurate representation of the environment.

It should be noted that the term real-time as used herein should be understood to encompass also pseudo-real-time whose characteristic time is generally in the order of human perception time (i.e., so that any time delays are sufficiently small to not affect inconvenience to the remote user or be unnoticeable). Considering the rendering of novel views of the arena 1000 may be relatively computationally intensive (even with optimizations such as those described above), in some embodiments of the disclosure, dynamic prioritization of the rendering of the novel view of the arena may be applied, in order to prioritize shorter time of rendering of the arena to users 1 whose virtual positions 2 face/engage with a certain machine 120 while optionally assigning lower priority to users 1 whose virtual positions 2 do not face any particular machine 120. Indeed, in the latter case, where the user generally faces the arena and not any specific machine, the rendering time required for producing a novel view may be longer, as there may exist many 3D dynamic elements/objects within the arena whose visuals should be incorporated/presented in the novel view. In this case, an illusion of instantaneous view of the arena may be maintained by the system 100 even when permitting the rendering time to be somewhat longer than the human perception time.

Dynamic prioritization may be achieved by the systems/methods of the disclosure by appropriately delaying/stretching the streaming time of the multimedia content of the arena to the user, to compensate for such delays, while maintaining the system's response to user inputs/movement substantially within acceptable bound of user perception. Conversely, when the user faces a specific machine 120 in the arena 1000, it is prioritized that the user obtains the view of the machine or its display/operation within short time in the order of human perception time (e.g., so he can duly react to any output of the machine). Therefore, in some embodiments the systems/methods of the disclosure prioritize the rendering of the view of the arena for such users whose virtual positions face certain particular machines. In this regard, it should be noted that the rendering time (e.g., the time to produce a novel view of the arena from such vantage points that face a certain machine) may also be significantly shorter than from a vantage point generally facing the arena.

The shortened rendering time may be for several reasons: for once because typically there is a smaller number of dynamically moving 3D objects in the field of view of such vantage point (e.g., the field of view is typically almost entirely occupied by the specific machine); and secondly, most of the field of view may be occupied by static elements (e.g., the machine’s cabinet), and significant parts thereof which may be dynamic/changing, such as the content shown on the machines display(s), that may be 2D elements which may be grabbed directly from the output of the machine (e.g., using the display adapters exemplified above), and embedded (e.g., with proper tilt/pan) in to the novel view provided to the user without requiring much computation (i.e., since the static elements need not be recomputed for every frame, and the dynamic elements are mostly the machines display whose embedding may requires small amount of computation e.g., for pan/tilt).

Additionally, in some embodiment the dynamic prioritization of the rendering implemented by the systems/method of the present disclosure may also include narrowing, and possibly fixating, the FOV provided to the user when his virtual position faces a certain machine, to exclude various elements except of the machine and its components from the FOV. In this case, employment of novel view generation may be obviated or reduced/limited to only few dynamic elements (e.g., such as moving leavers or blinking buttons of the machine) while other elements being rendered may include either static element that do not require retendering in every frame, and machines displays whose 2D imagery can be embedded directly as indicated above. Accordingly, in some embodiments the systems and methods of the disclosure may utilize the novel dynamic rendering prioritization technique described above, in order to facilitate rendering novel views of the arena 1000 in pseudo real-time to the convenience of the user, while mitigating the relatively high computational requirements of such novel view rendering.

In some embodiments, the system 100 is also adapted to provide (include in the multimedia content provided to the remote user) real time soundscape audio of the physical arena 1000 as would be hearable from the vantage-point of the current virtual user’s position 2. Soundscape production for the particular vantage point of the virtual user’s position 2 may include grabbing audio from one or more of the microphone audio-pickups 330 which are placed in vicinity to the vantage point 2, an optionally also from sound adapter audio-pickup of one or more of the electronic machines in the vicinity of the vantage point 2, and combine these audio sources (e.g., with proper volume equilibration and surround time delays) to create a realistic immersive special soundscape representing the arena from the particular vantage point 2. Optionally in some embodiments the volume equilibration of the various sources used to construct the sound scape depend on the direction to which the virtual user is facing (as indicated by the virtual user’s position 2 property). For example, if the virtual user’s position 2 faces a specific electronic machine, the machine's audio output may be emphasized while ambient sounds may be suppressed (e.g., this selective emphasis mimics the way our minds focus on a particular task, filtering out background noise).

To this end, in some implementations the system 100 includes a mapping data MD, including data indicative of the 3D positions of electronic machines 120 and/or of various components thereof (e.g., and/or of the respective volumes occupied thereby) in the arena, such as their displays, their cabinets, and control utilities (e.g., buttons, handles, touch pads/screens of the machines 120), within the arena 1000. The mapping may be a priory provided during the system’s setup, and/or updated upon a change of the location or orientation of any one or more of the machines 120. The mapping data may be inputted by an operator of the system, and/or determined automatically, or semi-automatically, using the combination of sensors e.g., imagers 310 in the arena, optionally by the aid of automatic mapping tools such as AI assisted tools capable for recognizing the machines 1000 or their parts, and their positions within the arena 1000. The mapping data may be stored in a memory/data-repository 102 (e.g., database) of the system 100, and may be used during operation of the system, to assist in the novel view generation of the arena 1000 from the vantage point of the user’s virtual position 2 as described above, and/or to assist in the creation of the sound scape described above, and/or for identification of the remote user interaction with one or more of the control utilities of the machines 120, as will be described in more details below.

For example, during generation of the arena view which is to be provided to the remote user’s multimedia equipment, the system 100 may utilize the mapping data MD to properly integrate the machines' displays’ output (e.g., as may be obtained from display adapters associated with one or more of the machines) in the visual view of the arena, e.g., in to the novel view generated from the vantage point 2). In this case the positional mapping allows the system 100 to accurately place these display outputs within the novel view with proper pan and tilt to ensure they appear naturally in the scene. Alternatively, or additionally, in production of the audio content of the arena, which is to be provided to the user, the mapping data MD may be used for combining and equilibrating the various audio sources with proper surround time delays to spatially align them with the visual elements in the scene to create a realistic sound environment as would be hearable from the desired vantage point. By combining the mapping data MD with real-time visual and audio inputs, the system 100 can produce a cohesive and immersive novel view and soundscape from any desired vantage point within the arena.

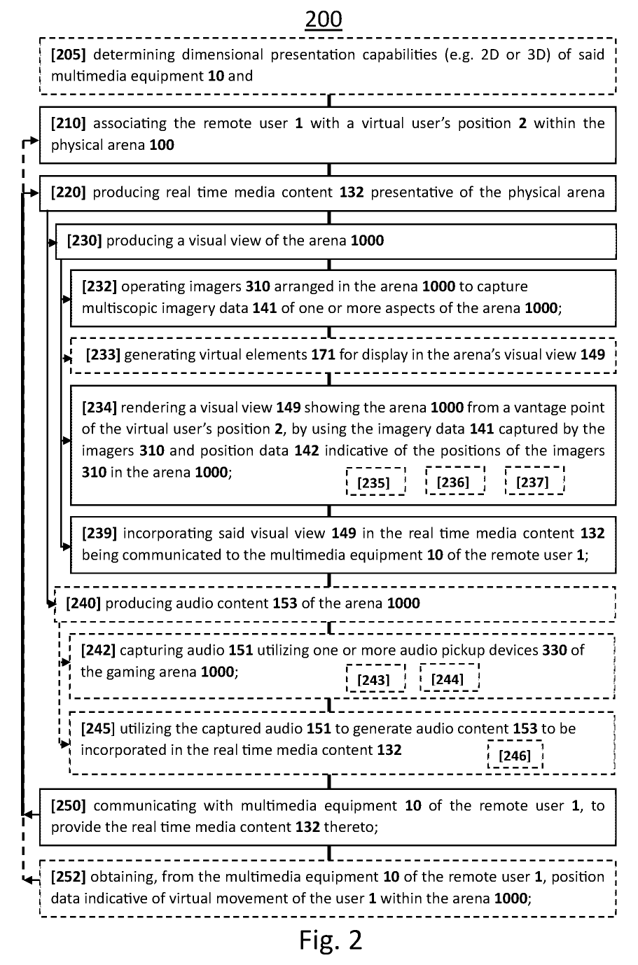

The system 100, as illustrated in FIG. 1, may be implemented by/with a computerized system including one or more processors 101, one or more memory utilities 102, e.g., data storage/repositories such as hard drives and computer memory chips and/or databases, as well as typically network communication devices 103 facilitating communication of the remote user’s multimedia equipment with the system 100. The system 100 may be implemented, for example using suitable computer executable code stored in memory 102 or another memory, which when executed by the processor causes the processor to perform the operations of the method 200 depicted in the flow chart of FIG. 2.

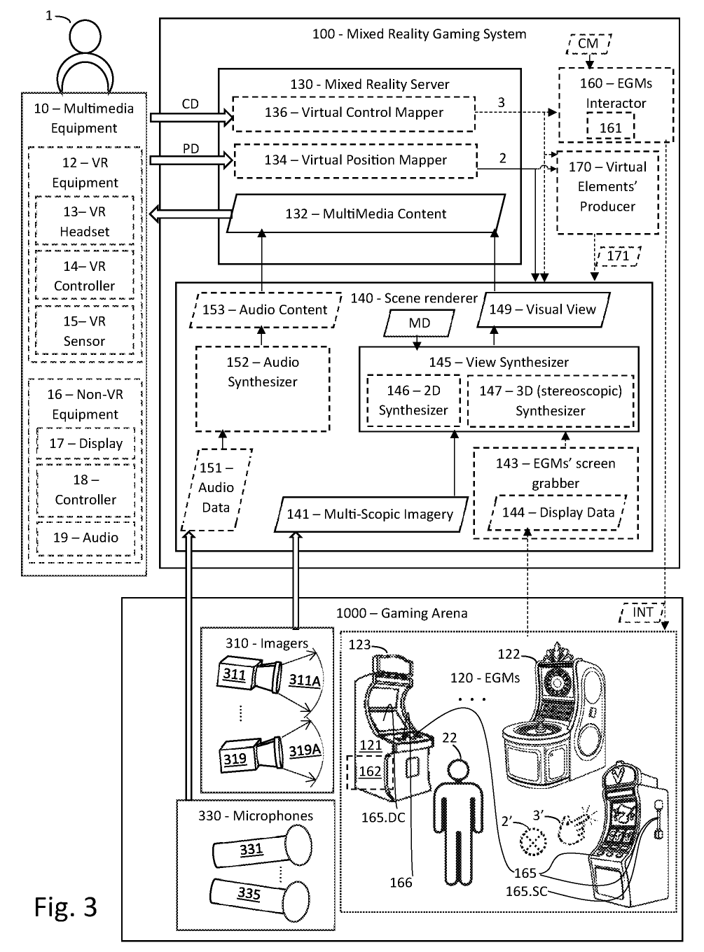

For brevity, the method 200, is described below, in conjunction with an example implementation of the system 100 of the disclosure depicted in FIG. 3, which is a block diagram in which various components or utilities or functions of the system 100 are depicted for clarity in blocks. It should be however understood, and would be appreciated by those versed in the art that the specific division of the system’s functions/utilities exemplified in this figure is only provided for the clarity of the example, and that the various aspects of the system may be implemented by computer executable code implementing the method operation of the disclosure, while optionally without being strictly divided to modules in the same manner as the blocks of FIG. 3. Moreover, it should be noted that for clarity in the non-limiting example below the system 100 and method 200 are described in example with reference to their implementation in relation to a gaming arena that includes a plurality of electronic gaming machines (EGMs). Yet, it should be understood various aspects of the technique of the disclosure, as well as of the system 100 and method 200, are not limited to this specific example and as will be appreciated by those versed in the art may be implemented for Mixed Reality of other types of arenas including various other types of electronic machines. For example, financial, industrial, and/or shopping arenas/market-places, or other arenas, which may be suitably equipped with electronic machines fitting their purposes.

Thus, with reference to FIG. 2, a flow diagram of Mixed Reality method 200 according to an embodiment of the present disclosure is illustrated. The method 200 is adapted to enable a remote user to explore a live physical arena 1000 from afar in real time. The arena 1000 may typically include a plurality of electronic machines (EMs) 120 that the remote user can view, and in some embodiments, also interact with. The method illustrated in the figure may be initiated after the remote user 1 had connected to the system 100 described above with his multimedia equipment 10 via a network (e.g., the internet or other suitable communication networks as may be supported by various implementations of the system 100 (e.g., WAN, LAN, BT etc.). The method is described herein with respect to a certain remote user 1, yet, it should be understood that the method 200 may be implemented to facilitate multiple remote users to access the live physical gaming arena from afar, e.g., simultaneously via the mixed reality system 100.

Typically, the multimedia equipment 10 of the user 1 includes VR equipment 12 capable of presenting virtual reality view of the arena(3D) remote user 1 in three-dimensional form. VR equipment 12 As illustrated in FIG. 3, VR equipment 12 may include for example a VR headset 13 (e.g., facilitating 3D display and audio), and optionally VR sensors 15 capable of tracking user’s movements/gestures) and/or VR controller(s) 14. Optionally, in some embodiments the remote user 1 may also connect to the system 100 with non-VR equipment 16 including for instance a display 17 (e.g., 2D display/screen), and optionally audio device 19, and/or controllers 18 (e.g., or any other computerized system associated with the same). In embodiments facilitating connection to the system 100 with non-VR equipment 16, the method 200 includes the optional operation for determining dimensional presentation capabilities of said multimedia equipment 10 (e.g., is the equipment a VR equipment 12 capable of presenting 3D view of the arena to the user, or a non-VR equipment 16 capable of presenting only 2D views). Accordingly, in such embodiments the mode of operation of the system to stream VR multimedia content (VR mode) or non-VR content (non-VR mode) may be set according to the capabilities of the remote user’s equipment 10. Optionally, the method 200 / system 100 are adapted to enable the user to selectively set the mode of operation to VR mode) or non-VR mode when his equipment permits both. Such setting may be enabled a priory upon connection to the system, and/or optionally also during the user’s engagement with the system 100.

The method 200 includes the following operations which are carried out after the remote user 1 has been connected to the system 100, via his multimedia equipment 10:

Operation includes associating the remote user 1 with a certain virtual user’s position 2 within the physical gaming arena 100. The initial user position 2 may be for example a certain default position. As will be appreciated from the below description, the user 1 may be allowed to change his position 2 in the arena 1000 during his engagement with the system, e.g., utilizing the controllers or sensors associated with his multimedia equipment. In this regard, the system 100 may for example include a mixed reality server utility 130 (e.g., implemented by software and/or hardware) that is adapted to communicate with multimedia equipment 10 of a remote user 1 to facilitate his connection to the system 100, and upon connection associates the remote user 1 with the virtual user’s position 2 within the physical gaming arena 1000.

Operation of method 200 includes producing real time media content 132 presentative of the physical gaming arena 1000, from the virtual user’s position 2 within the physical gaming arena 1000. This operation typically includes operation for producing a visual view 149 of the arena 1000 would be appeared from a vantage point of the virtual user’s position 2, and optionally supplementing/enhancing the visual view 149 with one or more virtual elements 171 as described below in relation to operation . Typically, the operation of producing the visual view 149 includes the following operations:

operating one or more of a plurality of imagers 310 (e.g., 111 to 119) distributed in the arena 1000 to capture multiscopic (i.e., at least stereoscopic) imagery 141 indicative of one or more aspects (i.e., view aspects; e.g., 111A to 119A; i.e., perspective-views/vantage-point-views) of the arena 1000. In this regard the imagery data 141 may be selectively collected from only those imagers 310 that capture perspective-views/ aspects 111A to 119A that are relevant for the creation of the visual view 149 of the arena 1000 from the vantage points of the user’s virtual position 2.

Then operation is carried out and includes rendering a visual view 149 of the physical arena 1000 as viewed from the vantage point of the user’s virtual position 2. in real time whereby said rendering is performed utilizing mapping data MD indicative of the positions (i.e., locations and orientations) of the imagers 310 in the gaming arena 1000, and the imagery data 141 captured by the imagers 310. As will be appreciated by those versed in the art, the rendering may include view synthesis techniques as described, optionally where required also utilizing the novel-view generation technique described above based on the outputs of the relevant imagers 310 and their positions.

To this end, as illustrated in FIG. 3, the system 100 may be associated with, or connectable to, the plurality of imagers 310 (e.g., 111 to 119) distributed in the arena 1000 such that they facilitate multiscopic capture of imagery data therefrom. The system 1000 may also include a scene renderer utility 140 (which may be implemented by software and/or hardware) which can be connected to the plurality of imagers 310 and adapted to utilize mapping data MD indicative of their positions in the arena 1000 and the imagery data 141 captured thereby to render the visual view 149 of the arena 1000 as viewed from the vantage point of the virtual user’s position 2, in real time. To achieve that the system 100 may include a view synthesizer 145, e.g., being implemented by computerized software and/or hardware, adapted to produce/synthesize the visual view 149 of the rendered scene from the perspective of the virtual user’s position 2, based on imagery data 141 obtained by at least two non-co-located imagers of the plurality of imagers 310 in which one or more aspects of the gaming arena 1000 that are visible from the virtual user’s position 2, are captured. This may be achieved by implementing the view synthesis and/or in some implementations the novel-view generation techniques described above. The scene renderer utility 140 may be connectable to, or in communication with, the mixed reality server utility 130 to provide the visual view149 thereto for inclusion in the real time media content 132 provided to the remote user. It should be understood, that typically the visual view is rendered frame by frame to form a 2D or 3D video-footage that can be streamed to the user’s multimedia equipment 10 in substantially real time by the mixed reality server utility 130.

In turn, in operation , which may be performed by the mixed reality server utility 130, visual view 149 is incorporated in the real time media content 132 being communicated/streamed to the multimedia equipment 10 of the remote user 1. The mixed reality server utility 130 thereby provides the remote user 1 with real time media content 132 presentative of the physical arena 1000 as would be captured from the user’s virtual position 2.

To this end, optionally, in some implementations the rendering operations includes rendering of transient elements 22 into said visual view 149 of the arena 1000. Rendering the transient elements 22 may be used to provide the remote user 1 with an immersive experience of being physically located in the gaming arena 1000 in real time. More specifically transient elements 22 such as people/objects 22 which may be moving within the arena and captured by the imagers 310, may be rendered (e.g., based on the novel-view generation, in the manner they would be appear from the user’s virtual position 2.

Alternatively, in some embodiments or operational modes, the rendering of transient elements 22 may be avoided. Avoidance of rendering of transient elements 22 may be achieved using for example the view synthesis technique, or novel view generation optionally also based on a combination of current images of the arena 1000 with preceding images thereof in which the transient elements 22 do not appear. Indeed, in some case where real time rendering is prioritized (e.g., to reduce the rendering time), the rendering of transient elements 22 may be skipped so as to reduce the processing load of the rendering. In such cases where transient elements 22 are not rendered, the visual view 149 of the arena 1000 would show the arena 1000 as at present while without the transient elements therein.

Optionally according to some embodiments, the production of the visual view 149 of the arena 1000 also includes the operation of in which virtual elements 171 which are to be displayed/overlayed in the visual view 149, are produced and rendered such that they appear in the visual view 149 to be located at one or more positions in the arena 1000. In this regard the term virtual elements 171 should be understood as referring to elements which do not actually exist in the arena but are artificially added by the system/method of the disclosure, to the visual view thereof. Such virtual elements 171 may be used/provided in order to enhance the remote user’s experience, optionally facilitating him with visible control objects by which he can manipulate the machine’s 120 operations, or providing him with some indications, visual enhancements (e.g., aesthetics) or amusement elements. Virtual elements 171 rendered in the visual view 149 may include for example include one or more of the following:

a visualization (e.g., cursor/hand/tool shaped) of the virtual interaction control object 3 to be rendered at the position 3’ of the virtual control element (e.g., the position, operation and/or shape of such virtual interaction control objects may be controlled/manipulated by the user – e.g., via his controllers 14 / 18 or sensors 15) to affect some actions in the physical arena 1000 or of other virtual elements 171, as described below.

one or more amusement elements (e.g., gifts, bonus packages or other animations) to be rendered in the visual view 149 presented to the remote user 1 (optionally in some cases such amusement elements may be associated with some activation function which can be triggered by the remote user); and

one or more visual enhancement elements (e.g., virtual cabinets of one or more of the EGMs) to be rendered in the visual view 149 (e.g., instead of corresponding actual physical elements in the arena in order to enhance the aesthetic appeal of the arena 1000).

Accordingly, according to some embodiments, the system 100 of the disclosure may include a virtual elements producer utility 170 adapted to provide data indicative of one or more virtual elements 171 to be displayed within the visual view 145 of the arena 1000; and the scene renderer 140 may be further is adapted to generate and render visualization of the one or more virtual elements 171 in the visual view 149 the arena rendered thereby such that they appear in the visual view 149 as if they are located at one or more locations in the arena 1000.

It should be noted that the rendering operation [234] optionally includes sub-operation [237] in which the rendering [234] is adjusted according to the VR-Mode or non-VR-Mode which may be set in optional operation [205].

Indeed, as indicated above, by default, the system may for example be set operate in VR-mode, in which it communicates with the remote user’s VR equipment 12, to provide thereto with 3D imagery/video multimedia data facilitating the creation of an immersive VR experience. In this mode, VR-mode, visual view 149 is rendered such that it is indicative of three-dimensional view of the arena 1000 from the vantage point of the user’s virtual position 2. The rendering in this case includes rendering of a three-dimensional view, for example utilizing stereoscopic view synthesis 147, to produce two stereoscopic frames of the arena from the vantage point 2 of the user 1 (e.g., from two slightly shifted points one per “virtual eye” of the user) or otherwise create 3D image data by which the VR equipment of the user can construct a 3D view of the arena 1000.

In embodiments where the system 100 is capable of communicating/operating-with any of a VR equipment 12 and a non-VR equipment 16, of the remote user 1, the rendering mode may be set to VR-mode and/or non-VR mode according to the specific capabilities of the user’s equipment 10, and optionally also based on the user’s selection (in case his equipment permits both modes).

In the non-VR mode, the user’s equipment 10 is set (or configured in case of non-VR equipment) to present the visual view 149 of the arena to the user 1 in two-dimensional form. In this case the rendering operation is implemented as a two-dimensional rendering generating a two-dimensional view of the arena 1000 from the vantage point of the user’s virtual position 2 (e.g., utilizing 2D view synthesis 146 for producing the visual view 149 such that it includes two-dimensional visual data of aspects of the arena 1000 viewable from the virtual user’s position 2.

Optionally, yet typically, the operation of method 200 for production of the real time multimedia content 132 not only includes the generation of the visual view 149 but also includes optional operation to produce audio content 153 of the arena 1000. Optional operation includes sub-operation for capturing audio 151 from the arena 1000 utilizing one or more audio pickup devices 330, and sub-operation for producing audio content 153, which is to be introduced to the real time media content 132, based on the captured audio 151.

The capturing of audio 151 from the arena 1000 may be based on various sources and various types of audio pickup devices 330 may be used for this purpose. For instance, the method 200 may include: utilizing audio pickup devices 330 such as sound cards/adapters that can receive/capture audio outputs of one or more of the machines 120; and utilizing audio pickup devices 330 such as microphones capable of capturing ambient audio of the arena 1000. Accordingly, the system 100 may include, or be connectable to, one or more audio pickup devices 330 such as microphones distributed in the arena, and soundcards/adapted that are connectable directly or indirectly to the machines 120, or to some of them, for receiving their output audio.

The production of the audio content 153 may be implemented by the scene renderer 140 utility of the system 100, (e.g., by an audio synthesizer 152 component thereof). Optionally the production of the audio content 153 includes applying spatial audio processing to the captured audio 151 to generate a sound scape of audio hearable from vantage point of the virtual user’s position 2. For instance, the audio synthesizer 152 may be adapted to apply spatial audio processing/synthesis to the audio 151 captured by two or more of the audio pickup devices 330 to generate a sound scape of the audio hearable from the user’s virtual position 2. As will be appreciated by those versed in the art of spatial audio synthesis, e.g., and/or of surround sound production, such spatial audio synthesis may be performed based on data indicative of the various audio sources in the arena (e.g., the locations of microphones audio pickup devices in the arena and the locations of the machines 120 (or their speakers) of which output audio is optionally received by suitable audio adapters.

In operation of method 200, the multimedia content 132 that is produced in operation 220 (e.g., including the visual view 149 produces in sub-operation 230 and the audio content 153 produced in optional sub-operation 240) is communicated, e.g., by the Mixed Reality Server utility 130 to the multimedia equipment 10 of the remote user 1. This provides substantially real time media content 132 of the arena 1000 from presentation to the user, from the vantage point of the virtual user’s position 2. As indicated above the media content 132 may include data indicative of 2D or 3D view of the arena from the user’s vantage point (e.g., depending on the user’s equipment 10 and the selected mode of operation), and facilitates a mixed reality presentation of the physical arena 1000 (based on real time live imagery thereof) to the remote user 1 by the user’s multimedia equipment 10 (i.e., based on real time live imagery of the physical arena); and include said soundscape in the audio content 153 of said rendered scene.

Operations 220 to 250, as described above are typically repeated as long as the user is connected to the system 100 for viewing the arena 1000. In each repetition at least one real time image frame (at least two in case of 3D/stereoscopic image production) presenting the arena in live is produced and communicated back to the user’s equipment. Accordingly, a real time video data of the live events occurring in the arena as viewed from the user’s virtual position 2 is communicated to the user’s equipment 10.

Typically, the user may also move within the arena, i.e., change his virtual user’s position 2 therein, by utilizing the controls or sensors of his equipment 10. For instance, a virtual user 1 may be able to navigate the space within the arena 1000 to change his virtual position 2 therein, for example by using motion sensors, handheld controllers, and/or gesture tracking equipment if his VR equipment. Alternatively, or additionally, in case the user uses a non-VR equipment 16, he may navigate the space for instance by using traditional input devices like keyboards, mice, game controllers, or touchscreens ETC’.

They use these devices to move their avatars and interact with the virtual world, often through on-screen interfaces or designated control schemes. Both methods offer immersive ways to explore and interact within the virtual arena. Accordingly, the method 200 may include operation 252 for obtaining, from the multimedia equipment 10 of the remote user 1, position data PD indicative of virtual movement of the user 1 within the arena 1000, and updating the virtual user’s position 2 according to the updated position data PD. Upon such update the operations of the method 200 are repeated to thereby refresh the visual view 149 of the arena 1000 provided to the user’s equipment according to the changed user’s virtual position 2.

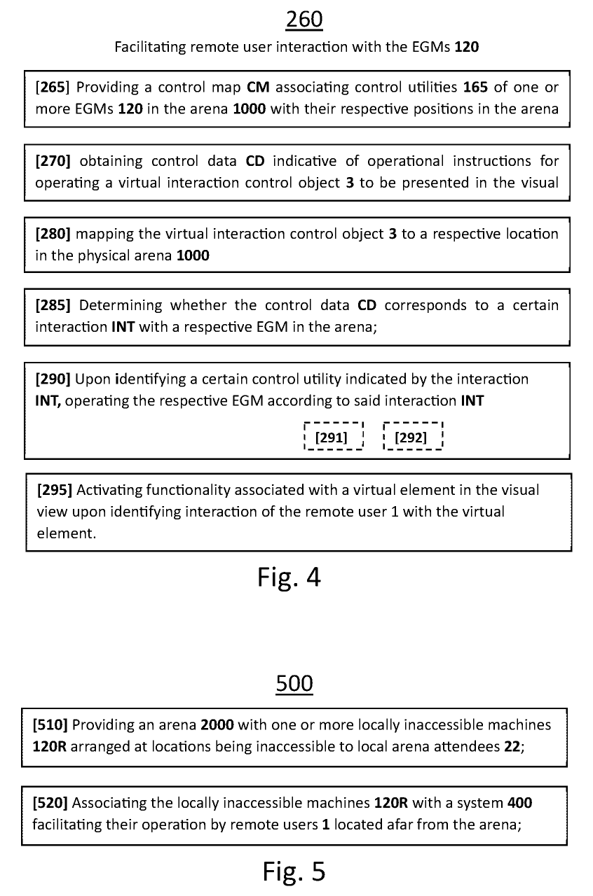

With reference back to FIG. 1, as indicated above in some embodiments the system 100 is adapted to facilitate interaction of the remote user 1 with one or more of the machines 120, i.e., to operate them remotely, based on the mixed reality view of the arena provided to him by the technique of method 200 described above. To achieve that, according to some embodiments the one or more processors 101 of the system may be adapted to perform the operations of the method 260 depicted in the flow chart of FIG. 4, which as described in the following facilitates remote operation of the machines by the remote user 1.

For brevity, and without loss of generality, the method 260, will now be described by way of example, with reference to the flow diagram of FIG. 4 in conjunction with the example block diagram implementation of the system 100 as depicted in FIG. 3.

Operation [265] of method 260 includes providing a control map CM associating control utilities 165 (e.g., buttons/touch pads/screens /handles) of one or more EGMs 120 in the arena with their respective positions in the arena 1000 (e.g., and/or with the respective volumes/voxels of the arena occupied thereby).

The control map CM may for example be included in the mapping data MD, which as described above may be produced/input during a calibration/setup stage of the system 100. To this end, it should be noted that the control map CM may include data indicative of both “static” and “dynamic” control utilities of the machines 120, e.g., depending on the types of controls of the machines 120 in the arena 1000. The term static controls 165.SC, is use herein to refer to physical peripherals/controls of the machine, such as push-buttons, leavers, joystick and/or other physical control utility, which may be physically furnished on the machine or its cabinet, and whose “existence” is not dependent on the operation state of the machine (e.g., independent of the game state executed by the machine – in case of gaming machine). Conversely the term dynamic controls 120.DC is used to refer to controls, such as those which may for instance be dynamically presented over a touch screen of a machine 120, whose display/appearance is selectively “toggled” by the machine, in accordance with its operational state (e.g., according to the state of the game executed by the machine – in case of gaming machined). For static controls 165.SC, control mapping CM may include data associating the positions/occupied-volumes thereof in the arena 1000. For dynamic controls 165.DC, control-map may include data indicative of the location/area at which the control is displayed (e.g., over a screen of the machine), in relation to the machine’s operational state/status at which it is displayed. In this manner, the system 100 / method 260 is facilitated with sufficient data to associate interaction of the user with a certain position in the mixed reality view of the arena presented to him, with an appropriate control (being static or dynamic, which may be located at that position (optionally depending on the respective machine state at that time – in case of dynamic controls).

Typically, when the system 100 operates in a mode facilitating remote user control over any one or more of the machines 120 (e.g., when method 260 is implemented by the system), apart from the user’s virtual position 2 within the arena, the remote user 1 may also be associated with at least one virtual interaction control object 3 (such as a virtual hand/tool) that also has a position within the arena 1000 that the user can move, and with which he user can interact with, and control, one or more of the machines 120 in the arena.

Accordingly, operation [270] of method 260 includes communicating with the multimedia equipment 10 of the remote user 1 to obtain therefrom control data CD indicative of operational instructions for operating/moving the virtual interaction control object 3 within the visual view 149 of the arena 1000. The control data CD may for instance include data indicative of a position or movement of the virtual interaction control object 3 relative to the arena 1000, and/or operational instructions encompassed thereby for activating a machine, such as pushing a button/ touch screen etc. The virtual interaction control object 3 is then mapped, in operation, based on the control data CD to a respective location 3’ in the physical arena 1000. The method 260 includes operation [285] for determining whether the control data CD received from the user’s equipment corresponds to a certain operational interaction INT to be communicated to a certain machine 120 in the arena 1000. This may be for instance performed by processing the operational instructions and/or movement data indicated by the control data CD received from the user’s equipment 10, in conjunction with the respective location 3’ of the virtual interaction control object 3 in the arena 1000 and in conjunction with the control map CM. For instance, in case it is identified based on the control map CM that the respective location 3’ of the virtual interaction control object 3 is encompassed to be within the volumetric region of a certain machine’s 120 static control e.g., 165.SC, the system 100/method 260 may determine the user wants to push/grab or otherwise operate that specific static control 165.SC.

Alternatively, or additionally, in case it is identified based on the control map CM that the virtual interaction control object 3 placed over the location of a touch screen or other dynamic controls container of a certain machine 120, the system 100/method 260 may communicate with the respective machine (e.g., via a relay or network communication associated therewith), to determine the state of the machine. Then, based on the control map CM the state of the machine, the system 100/method 260 may determine which dynamic controls 165.DC are presented on the respective touch-screen/dynamic-controls-container, and accordingly map the virtual interaction control object 3 to activation of appropriate one of the dynamic controls 165.DC currently presented. The state of the machine may be determined by system 100 of the disclosure for example by utilizing relay 162 which is connected to the respective machine to obtain therefrom data indicative of the machine’s state, and/or by communicating with the machine using a suitable network controller 161 in network communication with its computerized control system, to obtain said state data.

Accordingly, an interaction INT to operate the respective machine 120 may be determined in 285, by identifying the remote user’s interaction with either one of a static or dynamic controls of the machine.

Operation [290] is carried out upon identifying, in,[285] an interaction INT of the remote user with a certain control utility 166, be it static or dynamic, of the machine. Operation includes operating the respective machine (e.g., 121), that is associated with that certain control utility (e.g., 166), according to interaction INT such that the machine 121 operates in a manner similar to its operation in response to a local interaction made by a local user (e.g., 22) with the respective control utility 166. In some embodiments, the method operation [290] for operating the respective machine 121 according to the remote user’s 1 interaction INT may include at least one of the following operations:

[291] Utilizing a relay utility 162 that is connected to the respective machine 121 for delivering operational signals to the machine 121 to affect its operation in the manner similar to its normal operation via the certain control utility 166; and

[292] Utilizing a network controller 161, being in network communication with computerized control system of the respective machine 121, to affect its operation in the manner similar to its normal operation via the certain control utilities 166.

To this end, with reference to FIG. 3 the system 100 may be configured/operable for example as follows to facilitate the remote user interactions/operations with/of the physical machines 120 of the arena 1000, which are presented to him in the mixed reality view. The mixed reality server 130 may be adapted to communicate with multimedia equipment 10 of the remote user 1 to obtain position data indicative of virtual movement of the user 1 within the gaming arena 1000. The system 100 includes a virtual position mapper 134 that is adapted to process the position data obtained from the multimedia equipment 10 of the remote user 1 and update the virtual user’s position 2 within the gaming arena 1000 based on the position data. The scene renderer 130 is connectable to the virtual position mapper 134 for obtaining the updated virtual user’s position therefrom and is adapted to update the visual view 149 of the arena being rendered for the user 1 according to the updated user’s virtual position 2. The mixed reality server 130 is capable of communicating with multimedia equipment 10 of the remote user 1 to receive therefrom control data CD to operate a virtual interaction control object 3 (e.g., a virtual hand) within the visual view 149 of the arena 100. The control data CD may be processed by a virtual control mapper utility 136 that is adapted to process the control data CD and infer therefrom operational instructions to be applied to the virtual interaction control object 3 and thereby determine a location of the virtual interaction control object 3 within the visual view 149 of the arena 1000. A machine’s interactor utility 160, which may be included in the system 100, processes the location of the virtual interaction control object 3 in conjunction with the control mapping CM to determine whether said location of the virtual interaction control object 3 and the control data CD correspond to a certain interaction INT with at least one respective machine 121, and operate the respective machine accordingly. To this end the machine’s interactor 160 is adapted to utilize the control mapping CM to associate control utilities 165 (e.g., buttons/touch pads/screens /handles) of one or more of the machines 120 with their respective positions in the arena 1000, and utilize the location of the virtual interaction control object 3 and the respective positions of the machine’s control utilities 165 to identify the control utility (e.g., 166) whose interaction with is indicated by the interaction INT. As indicated above the system 100 is associated with one or more machine relays 162 (only one is shown in the resent non-limiting example associated with machine 121) and/or with a machine’s network, controller 161, by which the machine’s interactor 160 can communicate with the respective machines 121 to affect their operation according to the remote user’s interaction INT in a manner similar to their operation via their respective control utilities 165.

In some embodiments, the method 260 further includes operation monitoring an interaction of the virtual interaction control object 3 with at least one other virtual element of the virtual element 171 (e.g., being a virtual amusement element), as may be produced and incorporated in the visual view 149, by optional operation 233 of method 200 described above. Upon determining that the virtual interaction control object 3 of the remote user 1 was moved to the location of the virtual element 171, or otherwise activated to engage with said element 171, a certain functionality may be activated. The certain function may be an amusement function such as an animation, bonus or credit or game related function, or some other function which may be associated with the virtual element 171. To this end, the virtual elements producer 170 of system 100 may be adapted to monitor an interaction of the virtual interaction control object 3 with at least one other virtual element 171 (e.g., being a virtual amusement element), and activate the certain functionality associated therewith upon such interaction.

Thus, according to some embodiments of the disclosure, the method 260 as described above may be incorporated with the method 200 and/or implemented by system 100, to thereby facilitate remote user’s operation of the machines 120 in the physical arena from afar, as well as optionally allowing users engagement with some enhancement virtual elements to increase his remote experience and engagement with the arena.

It should be noted that according to some embodiments one or more of the machines 120 included in the arena 1000 may be exclusively remotely operated machines 120R (e.g., 121R, 122R and 123R), which are adapted/arranged-in-the-arena, to be exclusively operable by remote users 1 that access the gaming arena from remote, for instance by system 100. In other words, the arena may include some machines 120R that cannot be operated by users/visitors physically attending the arena.

In this connection, FIG. 5 is a flow diagram of a method 500 to facilitate effective utilization of a physical arena having electronic machines therein. The method 500 includes the following:

[510]- Providing an arena with a plurality of machines 120 therein, wherein one or more of the machines 120R are setup such that they are locally inaccessible machines 120R to local attendees 22 of the arena (herein after locally inaccessible machines 120R – i.e., machines arranged in the arena at locations that are inaccessible for local attendees); and

[520]– Associating, e.g., connecting, the locally inaccessible machines 120R of the machines 120 in the arena (and possibly also other machines therein), with a system that facilitates their remote operation by remote users 1 which are located afar from the arena; The method 500 thereby enables operations of the locally inaccessible machines 120R in the arena by the remote users, thus facilitating to reduce the ground/floor space in the arena which is needed to accommodate the machines.

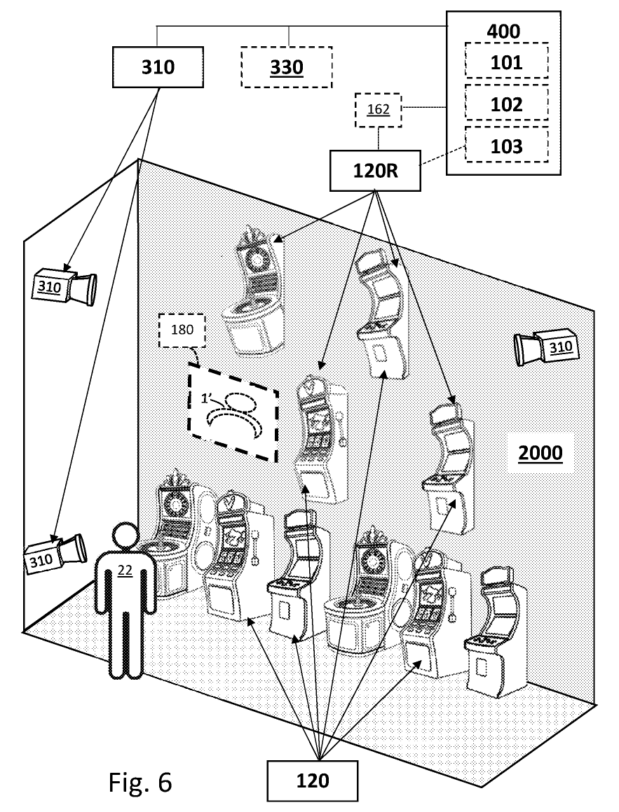

Further features of the method 500 will now be described in relation to particular example of a gaming arena 2000, as illustrated in FIG. 6. For instance, as illustrated in the example of FIG. 6 the locally inaccessible machines 120R are exclusively remotely operated gaming machines (EGMs) that are arranged in the arena 2000 at locations (e.g., heights in this case) which make them inaccessible for operation by local attendees/visitors (e.g., 22) who physically attend the arena 2000. Access to those machines is facilitated to for real time usage by 1 which access the arena 2000 via a system 400 that facilitates their remote operation (herein after also referred to as remote machine operation system 400).

The remote users 1 may be accessing and interacting with the arena/the machines therein from afar via the remote machine operation system 400. The remote machine operation system 400 may for example include, or be constituted by the system 100 described above, provided that the embodiments of said system 100 is adapted to enable the remote user 1 to operate one or more of the machines 120 in the arena 2000 from afar (e.g., an embodiment implementing the method 260 described above). Alternatively, or additionally in some implementations, the remote machine operation system 400, may not necessarily be a mixed reality system and may include for example any suitable system facilitating remote operations of machines from afar as for instance disclosed in U.S. Patent No. 11,468,728 titled system and method for remote control of machines which is assigned to the assignee of the present application; and/or by a system such as those disclosed in U.S. Patent No. 10,055,931 and U.S. Patent No. 10,818,127, both titled Gaming system and method, which are also assigned to the assignee of the present application. To this end, in some implementations the arena may include a plurality of imagers 310 distributed at several locations therein, and the system 400 may be adapted to collect imagery data from the imagers 310 and thereby facilitate the user with suitable view of the machine he wants to operate. In some cases, this may be achieved by the technique of the system 100 described above, which the system 400 may incorporate to produce mixed reality multimedia content 132 presenting the arena from a vantage point of a virtual position 2 of the remote user 1, and communicate the mixed reality multimedia content 132 to multimedia equipment 10 of the remote user 1 for presentation thereto. Alternatively, or additionally, this may be achieved based on the techniques as disclosed for instance in U.S. Patent No. 11,468,728 and/or U.S. Patent No. U.S. Patent No. 10,818,127, which are incorporated herein by reference (if so permitted). The system 400 may thus be adapted to provide multimedia content 132 indicative of the arena/machines therein to multimedia equipment 10 of the remote user 1.

The locally inaccessible machines 120R (EGMs in the specific non-limiting example of FIG. 6) may be machines that are configured/arranged such that they can only be exclusively remotely operated by remote users 1 that accessing the arena from afar, via system 400. For instance, the locally inaccessible machines/EGMs 120R may be placed (e.g., hanged) at a height that is not suited for their use/operation by local attendees/visitors 22 at the arena 1000.

In some implementations, which may have some relevance to gaming machines, but not only, the exclusively remotely operated machines 120R may be arranged in the arena 2000 such that at least display parts thereof, e.g., which show games played thereon/or other operations made by the remote user 1, are visible to local visitors 22 in the arena. For instance, the machines may be placed hanged at a height (e.g., from a wall of the arena) with suitable tilt such their display part is visible to local attendees/visitors in the arena (this may either facilitates the monitoring of the machine operations by local attendees/operators in the arena, and or to facilitate involvement (e.g., back betting) of local visitors with the game plays on those machines.

According to some embodiments, the system 400 is further adapted to produce an avatar character 1’ of a remote user 1 engaged with operation of one of the inaccessible machines 120R. In turn, the arena 2000 may for be for instance facilitated-with/include one or more of visual display utilities 180 arranged therein near one or more of the locally inaccessible machines 120R; and the system 400 may be adapted to operate/access a respective one of these visual display utilities 180 to display of the avatar character 1’ of the remote user 1 in vicinity of the respective machine 120R that is being remotely operated by him. For instance, the visual display utilities 180 may include one or more of the following:

a projector or display screen arranged at said arena 2000 and adapted to present said avatar 1’ in 2D form at a surface (e.g., a wall) near said certain machine such that it is visible to local visitors 22 of the arena 2000;

a holographic projector arranged at said arena 2000 and adapted to present said avatar character 1’ in 3D form at near said certain machine, such that it is visible to local visitors of the arena 2000; and

an augmented reality viewer for use by local visitors 22 in said arena 2000 being operated to augment the reality of said arena viewed thereby with said avatar character 1’ of the remote user 1 located near said certain machine that is being operated by him from afar.

To this end, it should be noted that according to an aspect of the disclosure the system 400 may be a computerized system 400 equipped with one or more processors 101, one or more memory utilities 102, as well as typically network communication devices 103 facilitating communication of the remote user’s multimedia equipment with the system 400, and possibly also facilitating communication of the system with the machines 120 for their operation. In some cases, the system 400 may also be associated with relay module 162 as described above that are connectable to corresponding one or more of the machines 120 and capable of delivering operation signals thereto to affect their operation. The system may be operable according to any suitable technique as indicated above facilitating remote operation of one or more of the machines 120 by remote users 1 located afar from the arena 1000. In some implementations the system is further adapted to be connected to one or more locally inaccessible machines 120R in the arena which are arranged at locations that are inaccessible to local visitors 22 physically attending the arena, and to one or more of visual display utilities 180 arranged in the arena 2000 in vicinity to said locally inaccessible machines 120R and is configured and operable to: produce an avatar character 1’ of a remote user 1 operating a certain locally inaccessible machine 120R of the arena; and operate a respective one of said visual display utilities 180 in the arena 2000 to display said avatar 1’ of the remote user 1 in vicinity of a certain machine 120R that is being remotely operated by him. To this end, he system 400 is adapted to obtain data indicative of posture of the remote user 1 from sensors associated with his multimedia equipment 10 and produce said avatar character 1’ according to this posture.

### Examples

Example 1: A Mixed Reality System 100 for a physical gaming arena 1000 including electronic gaming machines (EGMs) 120, the system 100 includes:

a plurality of imagers 310 (e.g., 111 to 119) to be distributed in a gaming arena 1000 that includes one or more electronic gaming machines (EGMs) 120. The plurality of imagers 310 are arranged such that they facilitate multiscopic (e.g., at least stereoscopic) capture of imagery 141 indicative of one or more aspects (e.g., 111A to 119A) of the gaming arena 1000.

a mixed reality server 130 adapted to communicate with multimedia equipment 10 of a remote user 1, associates the remote user 1 with a virtual user’s position 2 within the physical gaming arena 1000, and provides thereto, real time media content 132 presentative of the physical gaming arena 1000 as would be captured from the virtual user’s position 2; and

a scene renderer 140 connectable to the plurality of imagers 110 and adapted to utilize mapping data MD indicative of the positions (i.e., locations and orientations) of the imagers 310 in the gaming arena 1000, and the imagery data 141 captured by the imagers 310, to render a visual view of the physical gaming arena 1000 as viewed from the virtual user’s position 2 (e.g., from the vantage point of the virtual user’s position 2), in real time, and provide the same to the mixed reality server 130 for inclusion in the real time media content 132 provided to the equipment 10 of the remote user 1.

Example 2: The system 100 according to Example 1, wherein the scene renderer 140 utilizes view synthesis 145 (e.g., novel view generation) to produce the visual view 149 of the physical gaming arena 1000. The visual view 149 is produced such that it shows the gaming arena 1000 from the perspective of the virtual user’s position 2. The visual view 149 is produced based on imagery data 141 obtained by at least two non-co-located imagers of the plurality of imagers 310, in which one or more aspects of the gaming arena 1000 that are visible from said virtual user’s position 2, are captured. Accordingly, the visual view 149 is produced such that it shows a live/concurrent view of the arena (e.g., and actions taking place there).

Example 3: The system 100 according to Example 2, wherein the scene renderer 140 is adapted to render said visual view 149 such that it is indicative of three-dimensional view of the gaming arena 100 as would be viewed from the virtual user’s position 2. For rendering the three-dimensional visual view, the scene renderer 140 utilizes stereoscopic view synthesis 147 to produce said visual view 149 in 3D (e.g., synthesizing two stereoscopic live images of the arena one for each eye of the user). Accordingly the multimedia equipment 10 of the remote user with which the mixed reality server is adapted to communicate, may include VR equipment 12 (e.g., XR-equipment such as virtual/mixed/augmented reality gear/setup) capable of presenting the three dimensional visual view to the remote user 1.

Example 4: The system 100 according to Example 2 or 3, wherein the visual view 149 is indicative of two-dimensional visual data of aspects of the gaming arena 1000 viewable from the virtual user’s position 2.

Example 5: The system 100 according to any one of Examples 1 to 4, wherein the scene renderer 140 is adapted to render transient elements 22, such as people or objects which may be moving within the scene and visible from the virtual user’s position 2, into the visual view 149 of the scene, in real time (live), thereby providing the remote user 1 with an immersive experience of being physically located in the gaming arena 1000 in real time (e.g., in live at the time actions take place at the arena).

Example 6: The system 100 according to any one of Examples 1 to 5, wherein the mixed reality server 130 is adapted to communicated with the multimedia equipment 10 of the user 1 including any one of: a VR equipment 12 capable of presenting the visual view 149 to the remote user 1 in three-dimensional form; and a non-VR equipment 16 of presenting said visual view 149 to the remote user 1 in two-dimensional form. The mixed reality server 130 is adapted to operate the scene renderer 140 according to the capabilities of the multimedia equipment 10 of the user to render the visual view 149 as three-dimensional or two-dimensional view of the gaming arena 100 respectively.

Example 7: The system 100 according to any one of Examples 1 to 6, further including one or more audio pickup devices 330 capable of capturing audio 151 from the gaming arena 1000. The scene renderer 140 is adapted to utilize the captured audio 151 to introduce audio content 153 to the multimedia content 132 of the gaming arena 1000 provided to the remote user 1.

Example 8: The system 100 according to Example 7, wherein the scene renderer 140 (e.g., audio synthesizer 152 thereof) applies spatial audio processing to the audio 151 captured by two or more of the audio pickup devices 330 to generate a sound scape of the audio hearable from said virtual user’s position 2 and include that soundscape in the audio content 153 which is communicated to the remote user’s equipment 10.

Example 9: The system 100 according to Example 7 or 8, wherein the one or more audio pickup devices 330 used for capturing the audio 151 is include one or more of the following:

audio pickup devices 330 (e.g., sound cards) capable of receiving audio outputs of one or more of said EGMs 120; and

audio pickup devices 330 (e.g., microphones) capable of capturing ambient audio of the arena;

Example 10: The system 100 according to any one of Examples 1 to 9, wherein the mixed reality server 130 is adapted to communicate with multimedia equipment 10 of the remote user 1 to obtain position data indicative of virtual movement of the user 1 within the gaming arena 1000. The system 100 includes a virtual position mapper 134 that is adapted to process the position data obtained from the multimedia equipment 10 of the remote user 1 and update the virtual user’s position 2 within the gaming arena 1000 based on the received position data.

Example 11: The system 100 according to Example 10 wherein the scene renderer 130 is connectable to the virtual position mapper 134 to obtain the updated virtual user’s position therefrom and is adapted to update the visual view 149 of the arena 100 being rendered to the user according to the updated virtual user’s position 2.

Example 12: The system 100 according to any one of Examples 1 to 11 adapted to communicate with multimedia equipment 10 of the remote user 1 to enable the user to operate one or more of the EGMs 120 in the arena. The mixed reality server 130 is adapted to associate the remote user 1 with a virtual interaction control object 3 (e.g., a virtual hand) which the user 1 can control within the visual view 149 of the arena 1000 displayed to him. The system 100 includes a virtual control mapper 136 that is adapted to obtain control data CD indicative of operation instructions to be applied by the virtual interaction control object 3 from the multimedia equipment 10 of the remote user 1, and thereby determine a location of the virtual interaction control object 3 within the visual view 149 of the arena 1000. The system 100 further includes an EGMs interactor 160 adapted to identify whether the location of the virtual interaction control object 3 and operations indicated by the control data CD correspond to a certain interaction INT with at least one respective EGM of the EGMs 120 in the arena, and operate the respective EGM accordingly.

Example 13: The system 100 according to Example 12, wherein the EGMs interactor 160 is adapted to associate control utilities 165 (e.g., buttons/touch pads/screens /handles) of one or more EGMs 120 with their respective positions in the arena 1000, and utilize the location of the virtual interaction control object 3 and the respective positions of the EGM’s control utilities 165, to identify a certain control utility (e.g., 166) of a certain EGM (e.g., 121), whose interaction with is indicated by the certain interaction INT made by the remote user 1. Accordingly, the EGMs interactor 160 is adapted to operate the certain EGM (e.g., 121) associated with that certain control utility (e.g., 166) according to the interaction INT, such that the EGM’s operates in a manner similar to its operation in response to a local interaction made by a local user (e.g., 22) with the respective control utility 166. For example, the operations on the real gaming machine may include game actions/instructions given by a user to play the real gaming machine, depositing real money to wager/bet on the results of a game to be played on the real gaming machine and collection of rewards, such as real money rewards, from the real gaming machine.

Example 14: The system 100 according to Example 12 or 13, wherein the EGMs interactor 160 includes, or is associated with, at least one of the following:

One or more EGM relays 162 (only one is shown in the resent non-limiting example associated with EGM 121) that are connectable to corresponding one or more of the EGMs 120 and capable of delivering operation signals thereto to affect their operation in the manner similar to their operation via their respective control utilities 165; and

an EGMs’ network controller 161 capable of communicating with respective computerized control systems of one or more of the EGMs 120 over a network to affect their operation in the manner similar to their operation via their respective control utilities 165.

Example 15: The system 100 according to any one of Examples 1 to 14, further includes a virtual elements’ producer 170 that is adapted to provide data indicative of one or more virtual elements 171 to be displayed within the visual view 145 of the arena 1000 provided to the user 1. In turn, the scene renderer 140 is adapted to generate/render visualization of the one or more virtual elements 171 in the visual view 145 of the arena rendered thereby, such that the virtual elements 171 appear in the visual view 149 as if they are located at one or more locations in the arena 1000.

Example 16: The system 100 according to Example 15 wherein the one or more virtual elements 171 include one or more of the following:

a visualization 3’ (e.g., cursor/hand/tool shaped) of the virtual interaction control object 3 to be rendered at the position of the virtual control element 3;

an avatar of the remote user, and/or of other remote users, at their respective virtual positions 2 in the arena;

one or more amusement elements (e.g., gifts, bonus packages or other animations) to be rendered in the visual view 145 presented to the remote user 1; and

one or more visual enhancement elements (e.g., virtual cabinets of one or more of the EGMs) to be rendered in the visual view 145 (e.g., instead of corresponding actual physical elements in the arena in order to enhance the aesthetic appeal of the arena 1000).

Example 17: The system 100 according to Example 15 or 16, wherein the virtual elements producer 170 is adapted to monitor an interaction of the virtual interaction control object 3 with at least one other virtual element 171 (e.g., being a virtual amusement element), and activate a certain functionality (e.g., amusement function, bonus function or game function) thereof upon the interaction of the virtual interaction control object 3 therewith.

Example 18: The system 100 according to any one of Examples 12 to 17, wherein one or more of the EGMs 120 in the gaming arena 1000 include one or more of exclusively remotely operated EGMs 120R adapted to be exclusively operable in real time by the remote user 1 accessing the gaming arena via system 100.

Example 19: The system 100 according to Example 18, wherein the exclusively remotely operated EGMs 120R are arranged at locations inaccessible for operation local users (e.g., 22) physically attending the gaming arena but are accessible for real time usage by the remote user 1.

Example 20: The system 100 according to Example 19, wherein one or more of the exclusively remotely operated EGMs 120R are arranged at a height not suited for their operation by local users at the arena.

Example 21: The system 100 according to Example 20, wherein at least display parts of said one or more exclusively remotely operated EGMs 120R are arranged (e.g., hanged-from/tiled-on) a wall of said arena at said height not suited for their use by the local users.

Example 22: The system 100 according to any one of Examples 19 to 21, wherein the one or more of the exclusively remotely operated EGMs 120R are arranged such that at least display parts thereof, which show games played thereon by the remote user 1, are visible to local users (e.g., 22) in the arena.

Example 23: The system 100 according to Example 22 wherein the virtual elements’ producer 170 is adapted to produce an avatar character 1’ to be associated with said remote user 1. The system further includes a virtual user projection utility 180 connectable to (or including) one or more visual display utilities; and wherein the virtual user projection utility 180 is adapted to obtain from the EGMs interactor 160 an indication about a certain EGM of the exclusively remotely operated EGMs 120R being operated by the remote user 1 and operate one or more of the visual display utilities to display the avatar 1’ of the remote user 1 in vicinity of that certain EGM.

Example 24: The system 100 according to Example 23 wherein the visual display utilities include at least one of the following:

a projector or display screen arranged at said arena 1000 and adapted to present said avatar character 1’ in 2D form at a surface (e.g., a wall) near said certain EGM such that it is visible to local users of the gaming arena 1000;

a holographic projector arranged at the arena 1000 and adapted to present said avatar character 1’ in 3D form near the certain EGM such that it is visible to local users of the gaming arena 1000; and

an augmented reality viewer for use by local users in said arena 1000; and whereby the virtual user projection utility 180 is adapted to operate said augmented reality viewer to augment the reality of said arena viewed thereby with said avatar character 1’ of the remote user 1 near the certain EGM with which he is interacting.

Example 25: The system 100 according to Example 24 wherein the virtual elements producer 170 is adapted to provide data indicative of the avatar character 1’ of the remote user to be displayed within the visual view 145 of the arena 1000 served to at least one of the remote user and other remote users of the system 100.

Example 26: A Mixed Reality Gaming method 200 enabling a remote user to explore, in live, a physical gaming arena 1000 including a plurality of electronic gaming machines (EGMs) 120, in real time from afar. The method 200 includes:

[210] associating the remote user 1 with a virtual user’s position 2 within the physical gaming arena 100; and

[220] producing real time media content 132 presentative of the physical gaming arena 1000; and

[250] communicating with multimedia equipment 10 of the remote user 1, to provide the real time media content 132 thereto;

wherein the producing [220] of the real time media content 132 includes producing a visual view 149 of the arena 1000 would be appeared from a vantage point of virtual user’s position 2 within the physical gaming arena 1000, by carrying out the following:

[232] operating one or more of a plurality of imagers 310 distributed in the gaming arena 1000 to capture multicopy imagery data 141 (e.g., at least stereoscopic imagery) that is indicative of one or more aspects (e.g., 111A to 119A) of the gaming arena 1000;

[234] rendering a visual view 149 of the physical gaming arena 1000 as viewed from the vantage point of the virtual user’s position 2, in real time. The rendering is performed utilizing mapping data MD indicative of the positions (i.e., locations and orientations) of the imagers 310 in the gaming arena 1000, and the imagery data 141 captured by the imagers 310; and

[239] incorporating the produced visual view 149 in the real time media content 132 being communicated to the multimedia equipment 10 of the remote user 1.

Example 27: The method 200 according to Example 26 wherein the rendering [234] of the visual view 149 utilizes view synthesis [235] (e.g., novel view generation) to produce a live view of the gaming arena from the perspective of the virtual user’s position 2, based on the imagery data 141 obtained by at least two non-co-located imagers of the plurality of imagers 310.

Example 28: The method 200 according to Example 27 wherein the visual view 149 is rendered such that it is indicative of three-dimensional view of the gaming arena 1000 from the vantage point of the virtual user’s position 2. the rendering [234] of the three-dimensional view, is performed utilizing stereoscopic/multiscopic view synthesis 147.

Example 29: The method 200 according to Example 28 wherein the communicating with multimedia equipment 10 of the remote user 1 includes communicating with VR equipment 12 (e.g., virtual/mixed/augmented reality gear/setup) of the remote user 1 that is capable of presenting said visual view 149 to the remote user 1 in three-dimensional form.

Example 30: The method 200 according to any one of Example 27 to 29, wherein the visual view 149 is rendered such that it is indicative of two-dimensional view of the gaming arena 1000 from the vantage point of the virtual user’s position 2.

Example 31: The method 200 according to any one of Examples 26 to 30, wherein the rendering[234] includes rendering transient elements [236] , such as people/objects which may be moving within the arena, being visible from the virtual user’s position 2 and captured by the imagers 310, into said visual view 149 of the arena 1000.

Example 32: The method 200 according to any one of Examples 26 to 31, wherein the multimedia equipment 10 of the user 1 may include any one of: a VR equipment 12 capable of presenting the visual view 149 to the remote user 1 in three-dimensional form; and a non-VR equipment 16 capable of presenting the visual view 149 to the remote user 1 in two-dimensional form. The method 200 includes determining [205] dimensional presentation capabilities (e.g., 2D or 3D) of the multimedia equipment 10 and adjusting [237] operation of the rendering [230] to three-dimensional or two-dimensional rendering according to the presentation capabilities respectively.

Example 33: The method 200 according to any one of Examples 26 to 32, wherein the producing of the real time media content further includes producing [240] audio content 153 of the arena 1000 by capturing [242] audio 151 from the gaming arena 1000 utilizing one or more audio pickup devices 330 and, generating the audio content 153 based on the captured audio 151.

Example 34: The method 200 according to Example 33, wherein the generation [245] of the audio content 153 includes applying spatial audio processing [246]to the captured audio 151 to generate a sound scape of audio hearable from vantage point of the virtual user’s position 2.

Example 35: The method 200 according to Example 33 or 34, wherein the capturing [242] of the audio 151 from the gaming arena 1000 utilizing the one or more audio pickup devices 330 includes one or more of the following:

[243] utilizing audio pickup devices 330 such as sound cards/adapters that are capable of receiving audio outputs of one or more of the EGMs 120; and

[244]utilizing audio pickup devices 330 (e.g., microphones) capable of capturing ambient audio of the arena;

Example 36: The method 200 according to any one of Examples 26 to 35, further includes: obtaining, from the multimedia equipment 10 of the remote user 1, position data PD indicative of virtual movement of the user 1 within the gaming arena 1000, updating the virtual user’s position 2 according to the position data PD; and repeating operations of the method 200 to at least update the visual view 149 of the arena 1000 according to the updated virtual user’s position 2.

Example 37: The method 200 according to any one of Examples 26 to 36, further adapted to facilitate remote user interaction 260 with one or more of the EGMs 120. Facilitating the remote user interaction includes:

[265] Providing a control map CM associating control utilities 165 (e.g., static utilities such as physical buttons/handles and/or dynamic utilities such as virtual controls presented on touch- pads/screens) of one or more EGMs 120 in the arena with their respective positions thereof in the arena 1000;

[270]communicating with the multimedia equipment 10 of the remote user 1 to obtain control data CD indicative of operational instructions for operating a virtual interaction control object 3 to be presented within the visual view 149 of the arena 1000 displayed to the user;

[280] mapping the virtual interaction control object 3 to a respective location 3’ in the physical arena 1000, based on the control data CD (e.g., the control data CD includes data indicative of a position or movement of the virtual interaction control object 3 relative to the arena 1000);

[285] Determining whether the control data CD correspond to a certain interaction INT with a respective EGM 121 of the EGMs 120 by processing the operational instructions indicated in the control data CD in conjunction with the respective location 3’ of the interaction control object 3 in the arena 1000 and the control map CM.

Example 38: The method 200 further including,[290] upon identifying a certain control utility (e.g., 166) is indicated by the certain interaction INT, operating a respective EGM 121, being associated with that certain control utility (e.g., 166), according to said certain interaction INT such that the EGM’s operates in a manner similar to its operation in response to a local interaction made by a local user (e.g., 22) with the respective control utility 166.

Example 39: The method 200 according to Example 38 wherein operating [290] the respective EGM 121 includes, at least one of the following:

[292] Utilizing a relay 162 connectable to the respective EGM for delivering operational signals to the EGM to affect its operation in the manner similar to its normal operation via the certain control utilities (e.g., 166); and

[291] Utilizing a network controller 161, being in network communication with computerized control system of the respective EGMs, to affect its operation in the manner similar to its normal operation via the certain control utilities (e.g., 166).

Example 40: The method 200 according to any one of Examples 26 to 39, further includes generating[233] data of virtual elements 171 to be display in the visual view 149 of the arena 1000 and rendering the virtual elements 171 such that they appear in the visual view 149 to be located at one or more positions in the arena 1000.

Example 41: The method 200 according to Example 40 wherein the one or more virtual elements 171 include one or more of the following:

a visualization (e.g., cursor/hand/tool shaped) of the virtual interaction control object 3 to be rendered at the position 3’ of the virtual control element;

an avatar of the remote user, and/or of other remote users, at their respective virtual positions 2 in the arena;

one or more amusement elements (e.g., gifts, bonus packages or other animations) to be rendered in the visual view 149 presented to the remote user 1; and

one or more visual enhancement elements (e.g., virtual cabinets of one or more of the EGMs) to be rendered in the visual view 149 (e.g., instead of corresponding actual physical elements in the arena in order to enhance the aesthetic appeal of the arena 1000).

Example 42: The method 200 according to Example 40 or 41, further includes monitoring [295] an interaction of the virtual interaction control object 3 with at least one other virtual element of the virtual element 171 (e.g., being a virtual amusement element), and activating a certain functionality (e.g., amusement function, bonus function or game function) associated with the at least one virtual element upon identification of said interaction therewith.

Example 43: The method 200 according to any one of Examples 37 to 41, wherein one or more of the EGMs 120 in the gaming arena 1000 include one or more of exclusively remotely operated EGMs 120R adapted to be exclusively operable in real time by the remote user 1 accessing the gaming arena remotely from afar.

Example 44: The method 200 according to Example 43 wherein the exclusively remotely operated EGMs 120R are arranged at locations inaccessible for operation local users (e.g., 22) physically attending the gaming arena but are accessible for real time usage by the remote user 1.

Example 45: The method 200 according to Example 44 wherein one or more of the exclusively remotely operated EGMs 120R are arranged at a height not suited for their operation by local users at the arena.

Example 46: The method 200 according to Example 45 wherein at least display parts of said one or more exclusively remotely operated EGMs 120R are arranged (e.g., hanged-from/tiled-on) a wall of the arena at a height not suited for their use by the local users.

Example 47: The method 200 according to Example 45 or 46, wherein said one or more of the exclusively remotely operated EGMs 120R are arranged such that at least display parts thereof, which show games played thereon by the remote user 1, are visible to local users (e.g., 22) in the arena.

Example 48: The method 200 according to Example 47, further includes producing an avatar character 1’ associated with said remote user 1; and operating one or more of the visual display utilities 180 in the physical arena to display the avatar 1’ of the remote user 1 in vicinity of a certain EGM being operated by him.

Example 49: The method 200 according to Example 48 wherein the visual display utilities 180 include at least one of the following:

a projector or display screen arranged at said arena 1000 and adapted to present said avatar 1’ in 2D form at a surface (e.g., a wall) near said certain EGM such that it is visible to local users of the gaming arena 1000;

a holographic projector arranged at said arena 1000 and adapted to present said avatar character 1’ in 3D form at near said certain EGM such that it is visible to local users of the gaming arena 1000;

an augmented reality viewer for use by local users in said arena 1000 being operated to augment the reality of said arena viewed thereby with the avatar character 1’ of the remote user 1 located near the certain EGM with which remote user interacts.

Example 50: A gaming arena 2000 including a plurality of EGMs 120 and a remote machine operation system 400 facilitating remote operation of one or more of the EGMs 120 in real time by remote users 1 located afar from the arena 1000. Wherein one or more EGMs 120R of the EGMs 120 are arranged at locations that are inaccessible to local visitors 22 of the gaming arena (physically attending the arena) and are accessible for use in real time by the remote users 1 who are accessing and interacting with the arena from afar via, the remote machine operation system 400.

Example 51: The gaming arena 2000 according to Example 50, wherein the remote machine operation system 400 includes, or is constituted by, the system 100 according to Example 12, and is thereby adapted to enable the remote user 1 to operate one or more of the EGMs 120 in the arena 1000;

Example 52: The gaming arena 2000 according to Example 50 or 51, wherein one or more of the inaccessible EGMs 120R can only be exclusively remotely operated by remote users 1 accessing the gaming arena from afar via system 400.

Example 53: The gaming arena 2000 according to Example 52 wherein one or more of the inaccessible EGMs 120R are placed (e.g., hanged) at a height that is not suited for their use by local visitors 22 at the arena 1000.

Example 54: The gaming arena 2000 according to any one of Examples 50 to 53 wherein the one or more of the exclusively remotely operated EGMs 120R are arranged such that at least display parts thereof, which show games played thereon by the remote user 1, are visible to local visitors 22 in the arena.

Example 55: The gaming arena 2000 according to Example 54, wherein at least display parts of the one or more exclusively remotely operated EGMs 120R are arranged (e.g., hanged-from/tiled) on a wall of the arena at said height that is not suited for their use by the local visitors 22.

Example 56: The gaming arena 2000 according to any one of Examples 50 to 55, wherein the system 400 is adapted to produce an avatar character 1’ of the remote user 1; and wherein the arena 2000 includes one or more of visual display utilities 180 arranged in the arena 2000 to facilitate display of the avatar character 1’ in vicinity of one or more of the EGMs 120. The system 400 is adapted to operate a respective one of the visual display utilities 180 in the arena 2000 to display the avatar 1’ of the remote user 1 in vicinity of a certain EGM 120 that is being remotely operated by the remote user 1.

Example 57: The gaming arena 2000 according to Example 56, wherein the one or more visual display utilities 180 include at least one of the following:

a projector or display screen arranged at said arena 2000 and adapted to present said avatar 1’ in 2D form at a surface (e.g., a wall) near certain EGM that can be remotely operated by the user such that it is visible to local visitors 22 of the gaming arena 2000;

a holographic projector arranged at said arena 2000 and adapted to present said avatar character 1’ in 3D form near the certain EGM, as it is operating said certain EGM and being visible to local visitors of the gaming arena 2000;

an augmented reality viewer for use by local visitors 22 in the arena 2000 being operated to augment the reality of said arena viewed thereby with the avatar character 1’ of the remote user 1 operating said certain EGM, located near the certain EGM that is being operated by the remote user from afar.

Example 58: The gaming arena 2000 according to any one of Examples 50 to 57, further includes a plurality of imagers 310 distributed at several locations in the arena, and wherein the system 400 is adapted to collect imagery data from the imagers 310 and thereby produce mixed reality multimedia content 132 presenting the arena from a vantage point of a virtual position 2 of the remote user 1, and communicate the mixed reality multimedia content 132 to multimedia equipment 10 of the remote user 1 for presentation thereto.

Example 59: A computerized system 400 to be connectable to machines 120 in an arena to facilitating remote operation of one or more of the machines 120 by remote users 1 located afar from the arena 1000. The system 400 is connected to one or more locally inaccessible machines 120R in the arena, which are arranged at locations that are inaccessible to local visitors 22 physically attending the arena, and to one or more of visual display utilities 180 arranged in the arena 2000 in vicinity to the locally inaccessible machines 120R, and is configured and operable to:

produce an avatar character 1’ of a remote user 1 operating a certain locally inaccessible machine 120R of the arena; and

operate a respective one of the visual display utilities 180 in the arena 2000 to display the avatar 1’ of the remote user 1 in vicinity of a certain machine 120R that is being remotely operated by him.

Example 60: The system 400 according to Example 59 being adapted to provide multimedia content 132 multimedia equipment 10 of the remote user 1. The system is connected 400 to one or more imagers 310 in the arena to receive imagery data therefrom and adapted to produce/render the multimedia content 132 based on the imagery data.

Example 61: The system 400 according to Example 59 or 60, wherein one or more of the following:

the multimedia equipment 10 of the user 1, is a virtual reality equipment 12 and the system 400 is adapted to produce the multimedia content as mixed reality content facilitating its display to the user 1 in 3D-form; and

obtain data indicative of posture of the remote user 1 from sensors associated with its multimedia equipment 10; and produce the avatar character 1’ of the remote user with said posture.

Example 62: A method 500 facilitating effective utilization of an arena with electronic machines therein, the method includes:

Providing an arena 2000 with a plurality of machines 120, wherein one or more of the machines 120 are locally inaccessible machines 120R that are arranged in the arena 2000 at locations that are inaccessible to local attendees 22 of the arena;

Associating/connecting at least the locally inaccessible machines 120R in the arena 2000, with a system 400 that facilitates their remote on-line operation by remote users 1 located afar from the arena 2000;

Thereby enabling operations of the inaccessible machines 120R in the arena by the remote users 1, (e.g., this enables to accommodate more machines in the arena while reducing the ground/floor space in the arena that is needed to accommodate these machines).

Example 63: The method 500 according to Example 62, wherein the remote machine operation system 400 includes, or is constituted by, the system 100 according to Example 12, and is adapted to enable the remote user 1 to operate one or more of the machines 120.

Example 64: The method 500 according to Example 62 or 63, wherein one or more of the inaccessible machines 120R can only be exclusively remotely operated from afar by remote users 1 accessing them via system 400.

Example 65: The method 500 according to any one of Examples 62 to 64, wherein one or more of the inaccessible machines 120R are hanged/placed at a height not suited for their use by local attendees 22 at the arena 2000.

Example 66: The method 500 according to any one of Examples 62 to 65, wherein the one or more of the exclusively remotely operated machines 120R are arranged such that their operation is visible to local attendees 22 in the arena 2000.

Example 67: The method 500 according to any one of Examples 62 to 66, wherein the system 400 is further adapted to: produce an avatar character 1’ of a remote user 1 operating at least one of the inaccessible machines 120R, and operate one or more of visual display utilities 180 in the physical arena 2000, to display the avatar 1’ of the remote user 1 near the machine operated thereby.

Example 68: The method 500 according to Example 67, wherein the one or more of visual display utilities 180 comprise at least one of the following:

a projector or display screen arranged at said arena 2000 and adapted to present said avatar 1’ in 2D form at a surface (e.g., a wall) near a remotely operated machine 120R such that it is visible to local attendees 22 of the arena 2000;

a holographic projector arranged at said arena 2000 and adapted to present the avatar character 1’ in 3D form at near a remotely operated machine 120R such that it is visible to local attendees 22 in the arena;

an augmented reality viewer for use by local attendees 22 in said arena 1000 being operated to augment the reality of said arena that is being viewed thereby, with the avatar character 1’ of the remote user 1 operating the machine.

Example 69: A computerized system including a processor adapted to implement any one or more of the methods 200, 260 and 500 described above.

Example 70: A computer-readable medium having stored thereon instructions that, when executed by a processor, cause the processor to perform any one or more of the methods 200, 260 and 500 described above.

The present disclosure was described above with particular relation to the field of gaming and in relation to gaming machines (EGMs) and gaming arenas. However, it should be understood, and will be appreciated by those versed in the art that aspects of the technique of the present disclosure described above are not limited to gaming machines and gaming arenas and may be implemented for other types of arenas and electronic machines, to facilitate remote users to explore the a and operate the machines therein, while utilizing the mixed reality technique of the disclosure. In this context, the term arena used herein may also refer to any physical area in which various electronic machines, which may be accessed/operated by the system/method of the present disclosure. For example, the arena may be an industrial, financial trading floor, or other arena which includes and facilitates exploration and/or operation of machines therein. The terms machines and electronic machines (EMs) may be generally understood as devices or apparatuses that use electronic components to perform various tasks, process data, or execute functions/operations thereof. Such machines typically feature control utilities such as buttons, touchscreens, dials, or other input methods that allow users to interact with and operate them.

1. A mixed reality system for a physical gaming arena including electronic gaming machines (EGMs), the system comprising:
a plurality of imagers to be distributed in the physical gaming arena that includes one or more EGMs, such that the plurality of imagers facilitate multiscopic capture of imagery data indicative of one or more aspects of the physical gaming arena;
a mixed reality server adapted to communicate with multimedia equipment of a remote user, associate the remote user with a virtual user’s position within the physical gaming arena and provide real time media content to the remote user presentative of the physical gaming arena as would be captured from the virtual user’s position;
a scene renderer connectable to the plurality of imagers and adapted to utilize mapping data indicative of positions of the imagers in the gaming arena and the imagery data captured by the imagers, to render a visual view of the physical gaming arena as viewed from the virtual user’s position, in real time, and provide the visual view to the mixed reality server for inclusion in the real time media content provided to the remote user.

2. The system of claim 1, wherein the scene renderer utilizes view synthesis to produce the visual view of the physical gaming arena as viewed from the perspective of the virtual user’s position based on imagery data obtained by at least two non-co-located imagers of the plurality of imagers in which one or more aspects of the gaming arena that are visible from the virtual user’s position are captured.

3. The system of claim 2, wherein the scene renderer is adapted to render the visual view such that it is indicative of a three-dimensional visual view of the physical gaming arena as would be viewed from the virtual user’s position; and wherein the scene renderer utilizes stereoscopic view synthesis to produce the three dimensional visual view, and wherein the multimedia equipment includes virtual reality equipment.

4. The system of claim 1, wherein the scene renderer is adapted to render transient elements, as would be visible from the virtual user’s position, into the visual view of the scene, in real time, thereby providing the remote user with an immersive experience of being physically located in the gaming arena in real time.

5. The system of claim 1, wherein the mixed reality server is adapted to communicate with the multimedia equipment including any one of:
virtual reality equipment capable of presenting the visual view to the remote user in three-dimensional form; and
non-virtual reality equipment capable of presenting the visual view to the remote user in two-dimensional form; and
to operate the scene renderer according to the capabilities of the multimedia equipment to render the visual view as a three-dimensional view or a two dimensional view.

6. The system of claim 1, further comprising one or more audio pickup devices capable of capturing audio from the gaming arena; and wherein the scene renderer is adapted to utilize the captured audio to introduce audio content to the multimedia content.

7. The system of claim 1, wherein the mixed reality server is adapted to communicate with multimedia equipment to obtain position data indicative of virtual movement of the user within the gaming arena; wherein the mixed reality system further comprising a virtual position mapper that is adapted to process the position data obtained from the multimedia equipment and update the virtual user’s position within the gaming arena based on the position data; and wherein the scene renderer is updated to obtain the virtual user’s position from the virtual position mapper and update the visual view of the arena being rendered, according to the updated virtual user’s position.

8. The system of claim 1, wherein the mixed reality server is adapted to associate the remote user with a virtual interaction control object which the remote user can control within the visual view of the arena displayed to remote user.

9. A mixed reality gaming method enabling a remote user to explore a physical gaming arena including a plurality of electronic gaming machines (EGMs), in real time from afar, the method comprising:
associating the remote user with a virtual user’s position within the physical gaming arena;
producing real time media content presentative of the physical gaming arena; and
communicating with multimedia equipment of the remote user, to provide the real time media content thereto;
wherein the producing of the real time media content comprises producing a visual view of the physical gaming arena from a vantage point of the virtual user’s position within the physical gaming arena, by carrying out the following:
operating one or more of a plurality of imagers in a gaming arena to capture multiscopic imagery indicative of one or more view aspects of the gaming arena;
rendering a visual view of the physical gaming arena as viewed from the vantage point of the virtual user’s position in real time whereby the rendering is performed utilizing mapping data indicative of the positions of the imagers in the gaming arena, and the imagery data captured by the imagers; and
incorporating the visual view in the real time media content being communicated to the multimedia equipment.

10. The method of claim 9, wherein the rendering of the visual view utilizes view synthesis to produce a view of the physical gaming arena from the perspective of the virtual user’s position, based on live imagery obtained by at least two non-co-located imagers of the plurality of imagers; and wherein at least one of the following:
the visual view is rendered such that it is indicative of three-dimensional view of the gaming arena from the vantage point of the virtual user’s position; the rendering of the three-dimensional view, is performed utilizing stereoscopic view synthesis; and the communicating with multimedia equipment of the remote user comprises communicating with virtual reality equipment capable of presenting the visual view to the remote user in three-dimensional form; and
the visual view is rendered such that it is indicative of two-dimensional view of the physical gaming arena from the vantage point of the virtual user’s position.

11. The method of claim 9, wherein the rendering comprises rendering transient elements visible from the virtual user’s position and captured by the imagers, into the visual view of the arena.

12. The method of claim 9, wherein the multimedia equipment of the user includes any one of: virtual reality equipment capable of presenting the visual view to the remote user in three-dimensional form; and a non-virtual reality equipment capable of presenting the visual view to the remote user in two-dimensional form; and wherein the method further comprising determining dimensional presentation capabilities of the multimedia equipment and adjusting operation of the rendering according to a three-dimensional rendering or a two dimensional rendering according to the capabilities respectively.

13. The method of claim 9, further comprising obtaining, from the multimedia equipment, position data indicative of virtual movement of the user within the physical gaming arena, updating the virtual user’s position according to the position data; and repeating operations of the method to at least update the visual view of the arena according to the updated virtual user’s position.

14. The method of claim 9, further adapted to facilitate remote user interaction with one or more of the EGMs; wherein facilitating the remote user interaction comprising:
providing a control map associating control utilities of one or more EGMs in the physical gaming arena with their respective positions in the physical gaming arena;
communicating with the multimedia equipment of the remote user to obtain control data indicative of operational instructions for operating a virtual interaction control object to be presented within the visual view of the arena displayed to the user;
mapping the virtual interaction control object to a respective location in the physical arena, based on the control data being indicative of a position or movement of the virtual interaction control object relative to the physical gaming arena;
determining whether the control data correspond to a certain interaction with a respective EGM of the EGMs by processing the operational instructions indicated in the control data in conjunction with the respective location of the interaction control object in the arena and the control map; and
upon identifying that a certain control utility is indicated by the certain interaction, operating the respective EGM associated with the certain control utility according to the certain interaction such that the EGM’s operates in a manner similar to its operation in response to a local interaction made by a local user with the certain control utility.

15. The method of claim 9, further comprising generating data of virtual elements to be display in the visual view of the physical gaming arena and rendering the virtual elements such that they appear in the visual view to be located at one or more positions in the arena.

16. The method of claim 15, further comprising monitoring an interaction of the virtual interaction control object with at least one other virtual element of the virtual element, and activating a certain functionality associated with the at least one virtual element upon identification of the interaction with the least one virtual element.

17. The method of claim 9, wherein one or more of the EGMs in the gaming arena include one or more of exclusively remotely operated EGMs adapted to be exclusively operable in real time by the remote user accessing the physical gaming arena remotely from afar and arranged at locations inaccessible for operation by local users physically attending the gaming arena.

18. The method according to claim 17, wherein the one or more of the exclusively remotely operated EGMs are arranged such that at least display parts thereof, which show games played thereon by the remote user, are visible to local users in the arena; and wherein the method further includes producing an avatar character to be associated with the remote user, and operating one or more visual display utilities in the physical arena to display the avatar of the remote user in vicinity of the certain EGM which is being operated by the remote user.

19. A computerized system comprising a processor adapted to implement the method according to claim 9.

20. A computer-readable medium having stored thereon instructions that, when executed by a processor, cause the processor to perform the method according to claim 9.
